(19) United States
(12) Patent Application Publication
(10) Pub. No.: US 2026/0032300 A1
(43) Pub. Date: Jan. 29, 2026

(54) METHOD AND APPARATUS FOR SEARCHING FOR CONTENT IN CONTENT STREAMING SYSTEM

(71) Applicant: TVING CO., LTD., Seoul (KR)

(72) Inventors: Dong Hwan KIM, Yongin (KR); Yong Hwan KIM, Seoul (KR); Chan Hyeong JOO, Gimpo (KR)

(21) Appl. No.: 19/348,099

(22) Filed: Oct. 2, 2025

Related U.S. Application Data
(63) Continuation of application No. PCT/KR2024/004729, filed on Apr. 9, 2024.

(30) Foreign Application Priority Data
Apr. 10, 2023 (KR) 10-2023-0046976
May 17, 2023 (KR) 10-2023-0063795
Nov. 3, 2023 (KR) 10-2023-0150514

(51) Int. Cl. H04N 21/25; H04N 21/232; H04N 21/235

(52) U.S. Cl. CPC H04N 21/251; H04N 21/232; H04N 21/2353

(57) ABSTRACT

The objective of the present disclosure is to search for content in a content streaming system, and an operating method of a server may comprise the steps of: acquiring a search word; using a language model trained on the basis of synopsis information included in metadata of content items, so as to determine a first vector corresponding to the search word; determining similarity between the search word and a first content item on the basis of the first vector corresponding to the search word and a second vector of the first content item; and providing a content search list including information about at least one content item including the first content item selected on the basis of the similarity.

### CROSS-REFERENCE TO RELATED APPLICATION(S)

The present application is a Continuation Application based on International Application No. PCT/KR2024/004729, filed on Apr. 9, 2024, which claims priority to a Korean patent application 10-2023-0046976, filed Apr. 10, 2023, a Korean patent application 10-2023-0063795, filed May 17, 2023, and a Korean patent application 10-2023-0150514, filed Nov. 3, 2023, the entire contents of which are incorporated herein for all purposes by these references.

### TECHNICAL FIELD

The present disclosure relates to a content streaming system, and particularly, to a method and apparatus for searching for content in a content streaming system.

### BACKGROUND

With the development of various technologies and changes in consumption trends, a great change has occurred in the way content is supplied and consumed. The development of digital technology, computer technology, Internet/communication technology, etc. has blurred the boundaries of the type of content and the subject of production, which has caused a great change in the creation and consumption patterns of content. Platforms have emerged that allow ordinary people to create and distribute content. In addition, ease of access to various contents has been secured, and various options for consumption methods have begun to be provided.

Among these many changes in the content industry, OTT (over the top) services exist. OTT service is a media platform based on Internet and mobile communication, and provides various contents to consumers without equipment such as a separate set-top box beyond existing broadcasting services. The concept of OTT service started by providing movies and television programs in the form of video on demand (VOD), but the OTT service is still expanding, by not only providing content created by OTT service providers but also expanding its scope to mobile platforms.

### SUMMARY

The present disclosure may provide a method and apparatus for effectively searching for content in a content streaming system.

The present disclosure may provide a method and apparatus for searching for content based on similarity between a search term and content in a content streaming system.

The present disclosure may provide a method and apparatus for determining similarity between a search term and content by using a language model in a content streaming system.

The present disclosure may provide a method and apparatus for determining a vector of a search term by using a language model trained based on metadata of content.

The present disclosure may provide a method and apparatus for determining a vector of a search term by using a language model trained based on a hashtag of content.

The present disclosure may provide a method and apparatus for determining a vector of a search term by using a language model trained based on a genre of content.

The present disclosure may provide a method and apparatus for determining a vector of a search term by using a language model trained based on a synopsis of content.

The present disclosure may provide a method and apparatus for determining a vector of a search term by using a language model trained based on the hashtag and synopsis of content.

The present disclosure may provide a method and apparatus for determining a vector of content by using a language model trained based on metadata of content.

The present disclosure may provide a method and apparatus for generating and providing a content search list based on similarity between a vector of a search term and a vector of content.

The technical problems solved by the present disclosure are not limited to the above technical problems and other technical problems which are not described herein will become apparent to those skilled in the art from the following description.

According to an example of the present disclosure, a method for operating a server in a content streaming system may include obtaining a search term, determining a first vector corresponding to the search term by using a language model trained based on synopsis information included in metadata of content items, determining a similarity between the search term and a first content item based on the first vector corresponding to the search term and a second vector of the first content item, and providing a content search list including information on at least one content item including the first content item selected based on the similarity.

According to an example of the present disclosure, the second vector of the first content item may be obtained through the language model that is trained based on the synopsis information.

According to an example of the present disclosure, the second vector of the first content item may be obtained by inputting sequence-type text data, which includes information included in first metadata of the first content item, into the language model trained based on the synopsis information.

According to an example of the present disclosure, the language model may be trained through training to predict synopsis information of the content items based on a masked language model (MLM).

According to an example of the present disclosure, the language model may be primarily trained through training to predict synopsis information of the content items based on the MLM and may be secondarily trained through training to predict hashtag information of the content items based on the MLM.

According to an example of the present disclosure, the language model may be primarily trained through training to predict hashtag information of the content items based on the MLM and may be secondarily trained through training to predict the synopsis information of the content items based on the MLM.

According to an example of the present disclosure, the determining of the first vector corresponding to the search term may include dividing the search term into token units, obtaining a transformed search term by inserting at least one separator into the search term that is divided into token units, and obtaining the first vector by inputting the transformed search term into the language model.

According to an example of the present disclosure, the transformed search term may include at least one of a separator token and a special token.

According to an example of the present disclosure, the method further includes converting text metadata describing content of the content items into sequence-type text data, masking a synopsis token located in a synopsis region of the sequence-type text data, and performing training of the language model to predict the masked synopsis token, and the text metadata may include at least one of a title, a synopsis, a composite genre, a director, an actor, or hashtag information.

According to an example of the present disclosure, the converting of the text metadata into the sequence-type text data includes dividing the text metadata into a plurality of tokens and generating the sequence-type text data by inserting at least one separator between the tokens, and the at least one separator may include at least one of a separator token for separating different types of features or a special token inserted before and after a specific feature to indicate the specific feature.

According to an example of the present disclosure, the masking of the synopsis token includes selecting a non-dependent token from among a plurality of synopsis tokens located in the synopsis region and masking the selected non-dependent token, and the non-dependent token may be a token that does not start with a specified symbol.

According to an example of the present disclosure, the training model is performed by using a prediction model, and the prediction model may include the language model that receives, as input, sequence-type text data including a masked synopsis token and outputs vector values corresponding to the sequence-type text data, and a masked language model (MLM) head layer that is configured to predict at least one input token corresponding to at least one vector value that is output from the language model.

According to an example of the present disclosure, each of the first vector and the second vector may be determined by assigning a weight to a vector value corresponding to a position of a specified feature among the output vector values of the last hidden layer of the trained language model.

According to an example of the present disclosure, the method further includes determining similarity between the search term and a plurality of content items based on the first vector corresponding to the search term and a vector of each of the plurality of content items, and the providing of the content list may include selecting two or more content items including the first content item from among the first content item and the plurality of content items, in descending order of similarity to the search term, and providing the content list including information on the selected two or more content items.

According to an example of the present disclosure, the method further includes, prior to determining the first vector corresponding to the search term, performing a text search based on the search term, and when a result obtained from the text search does not satisfy a specified condition, the determining of the first vector corresponding to the search term may be performed.

According to an example of the present disclosure, the specified condition comprises a condition regarding at least one of whether at least one content item is retrieved, or the number of retrieved content items.

According to one embodiment of the present disclosure, a server in a content streaming system includes a communication unit configured to transmit and receive signals with at least one client device and a processor electrically coupled with the communication unit, and the processor may obtain a search term, determine a first vector corresponding to the search term by using a language model that is trained based on synopsis information included in metadata of content items, determine a similarity between the search term and a first content item based on the first vector corresponding to the search term and a second vector of the first content item, and provide a content search list including information on at least one content item including the first content item selected based on the similarity.

According to an example of the present disclosure, a program stored in a recording medium, when executed by a processor, may perform any one of the above-described methods.

The features briefly summarized above with respect to the present disclosure are provided as an example only to explain the detailed description and are not construed to limit the scope of the present disclosure.

According to the present disclosure, content similar to a search term can be retrieved.

It will be appreciated by persons skilled in the art that that the effects that can be achieved through the present disclosure are not limited to what has been particularly described hereinabove and other advantages of the present disclosure will be more clearly understood from the detailed description.

### DESCRIPTION OF THE DRAWINGS

FIG. 1 illustrates a content streaming system according to an embodiment of the present disclosure.

FIG. 2 illustrates a structure of a client device according to an embodiment of the present disclosure.

FIG. 3 illustrates a structure of a server according to an embodiment of the present disclosure.

FIG. 4 illustrates the concept of a content streaming service according to an embodiment of the present disclosure.

FIG. 5 illustrates an example of a relative relationship between vectors.

FIG. 6 illustrates an example of the structure of a server that searches for content according to one embodiment of the present disclosure.

FIGS. 7A and 7B illustrate examples of the structure of a model learning unit according to an embodiment of the present disclosure.

FIG. 8 illustrates an example of converting text metadata of content into sequence-type text data according to an embodiment of the present disclosure.

FIGS. 9A and 9B illustrate an example of learning of a language model according to an embodiment of the present disclosure.

FIG. 9C illustrates an example of the structure of a prediction model according to an embodiment of the present disclosure.

FIG. 10A illustrates an example of learning of a language model according to an embodiment of the present disclosure.

FIG. 10B illustrates an example of an input/output structure of a prediction model according to an embodiment of the present disclosure.

FIG. 10C illustrates the concept of a multi-class prediction model and a multi-label prediction model applicable to the present disclosure.

FIG. 11 illustrates an example of calculating similarity between a search term and content by using a trained language model according to one embodiment of the present disclosure.

FIG. 12 illustrates an example of a procedure of searching for content by using a trained language model according to one embodiment of the present disclosure.

FIG. 13A illustrates an example of a procedure of performing learning for a language model according to one embodiment of the present disclosure.

FIG. 13B illustrates an example of learning of a language model using hashtag prediction according to one embodiment of the present disclosure.

FIG. 14A illustrates an example of a procedure for performing learning on a language model according to an embodiment of the present disclosure.

FIG. 14B illustrates an example of learning of a language model using genre prediction according to one embodiment of the present disclosure.

FIG. 15A illustrates an example of a procedure for performing learning on a language model according to an embodiment of the present disclosure.

FIG. 15B illustrates an example of a procedure of performing learning for a language model according to one embodiment of the present disclosure.

FIG. 15C illustrates an example of learning of a language model using hashtag and synopsis according to one embodiment of the present disclosure.

FIG. 16 illustrates an example of a procedure of determining similarity between a search term and content by using a trained language model according to one embodiment of the present disclosure.

FIG. 17 illustrates a specific example of a procedure of searching for content by using a trained language model according to one embodiment of the present disclosure.

FIG. 18 illustrates an example of search scenario according to one embodiment of the present disclosure.

FIG. 19 illustrates an example of performing a search based on a Python module according to one embodiment of the present disclosure.

FIG. 20 illustrates an example of performing a search based on an elastic search engine according to one embodiment of the present disclosure.

FIG. 21A illustrates an example of an architecture of a transformer applicable to one embodiment of the present disclosure.

FIG. 21B illustrates an example of a detailed structure of encoder and decoder blocks of a transformer applicable to one embodiment of the present disclosure.

FIG. 22 illustrates an example of a structure of a BERT model applicable to one embodiment of the present disclosure.

### DETAILED DESCRIPTION

Hereinafter, embodiments of the present disclosure will be described in detail with reference to the accompanying drawings so that those skilled in the art can easily carry out the present disclosure. However, the present disclosure may be embodied in many different forms and is not limited to the embodiments set forth herein.

In describing the embodiments of the present disclosure, a detailed description of known configurations or functions will be omitted when it may obscure the subject matter of the present disclosure. In the drawings, parts not related to the description of the present disclosure are omitted, and similar reference numerals denote similar parts.

The functional blocks shown in the drawings and described below are only examples of possible implementations. Other functional blocks may be used in other implementations without departing from the spirit and scope of the detailed description. Additionally, although one or more functional blocks of the present disclosure are represented as separate blocks, one or more of the functional blocks of the present disclosure may be a combination of various hardware and software configurations that perform the same function.

In addition, the expression of including certain components is an expression of “open type” and simply indicates that the corresponding components are present, and should not be understood as excluding additional components. Furthermore, when a component is referred to as being “connected” or “coupled” to another component, it should be understood that it may be directly connected or coupled to the other component or intervening components may also be present.

In addition, a singular expression for an object may be understood as a plural expression, unless the context clearly indicates otherwise. In the present disclosure, expressions such as “A or B” or “at least one of A and/or B” may be understood to include all possible combinations of the items listed together. Expressions such as “first”, “second”, and “third” may modify the object regardless of order or importance, and are used only to distinguish one object from other objects of the same kind.

In addition, in the present disclosure, “configured to” may be understood as having the meaning technically equivalent to any one of expressions of “suitable for”, “having the ability to”, “changed to”, “made to”, “capable of” and “designed to” in terms of hardware or software, depending on the situation, and may be replaced with each other.

The present disclosure is directed to searching for content in a content streaming system, and particularly, to describing a technology for searching for content by using a language model that is trained based on text-form metadata of content. Specifically, the present disclosure provides various embodiments for training a language model based on metadata of content and determining similarity between a search term and content by using the trained language model.

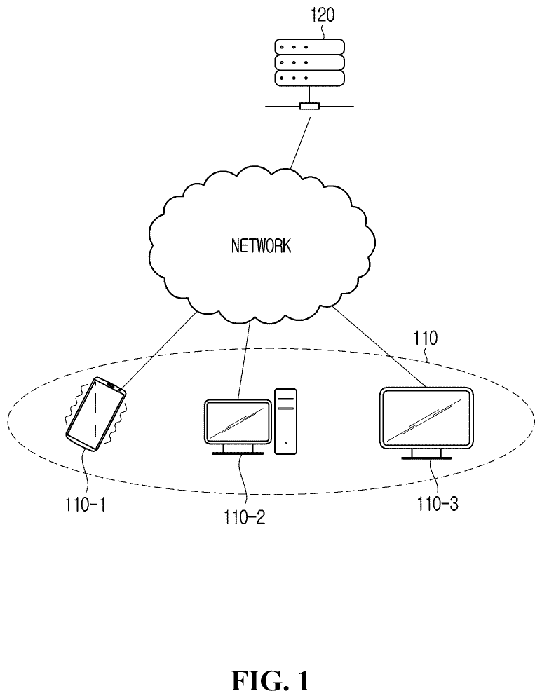

FIG. 1 illustrates a content streaming system according to an embodiment of the present disclosure. FIG. 1 illustrates a system for providing services related to content, such as content streaming and content-related information, and entities belonging to the system. Hereinafter, in the present disclosure, various services related to content may be referred to as a ‘content service’ or other terms having an equivalent technical meaning.

Referring to FIG. 1, the content streaming system may include a client device 110 and a server 120. Here, the client device 110 is illustrated as a set of three client devices 110-1 to 110-3, but the content streaming system may include two or less or four or more client devices. In addition, although one server 120 is illustrated, the content streaming system may include a plurality of servers that share various functions and interact with each other.

The client device 110 receives and displays content. The client device 110 may receive content streamed from the server 120 after accessing the server 120 through a network. That is, the client device 110 is hardware on which client software or applications designed to use the content service provided by the server 120 are installed, and may interact with the server 120 through the installed software or applications. The client device 110 may be implemented as various types of devices. For example, the client device 110 may be one of a movable portable device, a device that is movable but generally fixed during use, and a device that is fixedly installed at a specific location.

Specifically, the client device 110 may be implemented in the form of at least one of a smartphone 110-1, a desktop computer 110-2, a tablet PC, a laptop PC, a netbook computer, a workstation, a server, a personal data assistant (PDA), a portable multimedia player (PMP), a camera, or a wearable device. Here, the wearable device may be implemented in the form of at least one of an accessory type (e.g., watch, ring, bracelet, anklet, necklace, glasses, contact lens, HMD (head-mounted-device)), clothing type, body attachment type (e.g., skin pad or tattoo), or bio implantable circuit. In addition, the client device 110 is a home appliance, and may be, for example, implemented in the form of at least one of a television 110-3, a digital video disk (DVD) player, an audio system, a refrigerator, an air conditioner, a vacuum cleaner, an oven, a microwave oven, a washing machine, or an air purifier.

The server 120 performs various functions to provide content services. In other words, the server 120 may provide services related to content streaming and various contents to the client device 110 using various functions. Specifically, the server 120 may perform datafication to stream content, and transmit the content to the client device 110 through a network. To this end, the server 120 may perform at least one of content encoding, data segmentation, transmission scheduling, or streaming transmission. Additionally, for the convenience of content use, the server 120 may further perform at least one function of providing a content guide, managing a user's account, analyzing a user preference, or recommending content based on preference. A plurality of functions among the various functions described above may be provided, and for this purpose, the server 120 may be implemented as a plurality of servers.

The client device 110 and the server 120 exchange information through a network, and a content service may be provided to the client device 110 based on the exchanged information. In this case, the network may be a single network or a combination of various types of networks. The network may be understood as a form in which different types of networks are connected according to regions. For example, the networks may include at least one of a wireless network or a wired network. Specifically, the networks include a cellular network based on at least one of 6th generation (6G), 5th generation (5G), long term evolution (LTE), LTE Advance (LTE-A), code division multiple access (CDMA), wideband CDMA (WCDMA), and universal mobile telecommunications system (UMTS), wireless broadband (WiMAX), or Global System for Mobile Communications (GSM). Also, the networks may include a local area network based on at least one of a wireless local area network (WLAN), Bluetooth, Zigbee, near field communication (NFC), or ultra wideband (UWB). In addition, the networks may include wired networks such as the Internet and Ethernet.

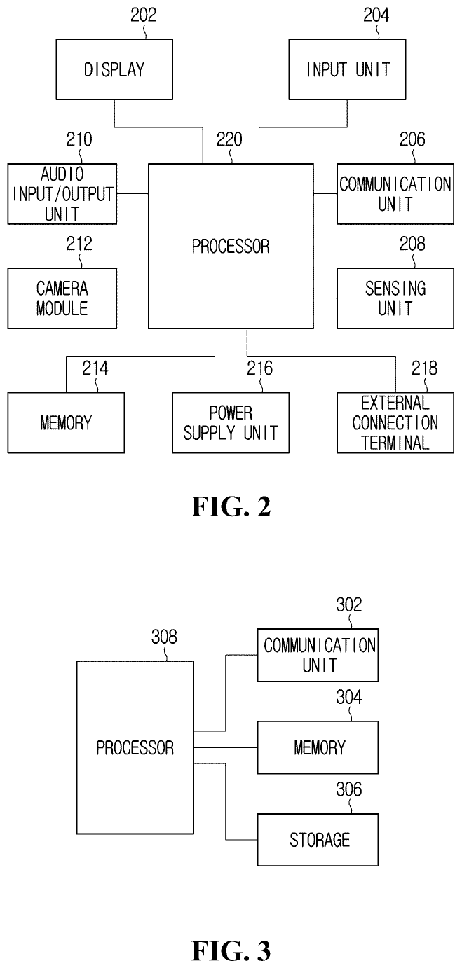

FIG. 2 illustrates a structure of a client device according to an embodiment of the present disclosure. FIG. 2 illustrates a block structure of a client device (e.g., the client device 110 of FIG. 1).

Referring to FIG. 2, the client device includes a display 202, an input unit 204, a communication unit 206, a sensing unit 208, an audio input/output unit 210, a camera module 212, a memory 214, a power supply unit 216, an external connection terminal 218 and a processor 220. However, depending on the type of device, at least one of the components illustrated in FIG. 2 may be omitted.

The display 202 outputs information such as visually recognizable images and graphics. To this end, the display 202 may include a panel and a circuit for controlling the panel. For example, the panel may include at least one of a liquid crystal display (LCD), a light emitting diode (LED), a light emitting polymer display (LPD), an organic light emitting diode (OLED), an active matrix organic light emitting diode (AMOLED) or a flexible LED (FLED).

The input unit 204 receives input generated by a user. The input unit 204 may include various types of input sensing units. For example, the input unit 204 may include at least one of a physical button, a keypad or a touch pad. Alternatively, the input unit 204 may include a touch panel. When the input unit 204 includes a touch panel, the input unit 204 and the display 202 may be implemented as one module.

The communication unit 206 provides an interface for enabling a client device to form a network with other devices and to transmit or receive data through the network. To this end, the communication unit 206 may include a circuit for physically processing signals (e.g., an encoder/decoder, a modulator/demodulator, a radio frequency (RF) front end, etc.), a protocol stack for processing data according to communication standards (e.g., modem), etc. According to various embodiments, the communication unit 206 may include a plurality of modules to support a plurality of different communication standards.

The sensing unit 208 collects sensing data including data on the state of the client device or the surrounding environment. For example, the sensing unit 208 may measure a physical value or a change in value related to an operating state or posture of the client device, and generate an electrical signal representing the measured result. In addition, the sensing unit 208 may measure a physical value or a change in value of the surrounding environment of the client device and generate an electrical signal representing the measured result. To this end, the sensing unit 208 may include at least one sensor and a circuit for controlling the at least one sensor. Specifically, the sensing unit 208 may include at least one of a gyro sensor, a magnetic sensor, an acceleration sensor, a grip sensor, a proximity sensor, a color sensor, a bio sensor, an air pressure sensor, a temperature sensor, a humidity sensor, an illuminance sensor, or an ultra violet (UV) sensor, an e-nose sensor, a gesture sensor, an electromyography (EMG) sensor, an electroencephalogram (EEG) sensor, an electrocardiogram (ECG) sensor, an infrared (IR) sensor, an iris sensor, or a fingerprint sensor.

The audio input/output unit 210 outputs sound according to electrical signals generated based on audio data and detects external sound. That is, the audio input/output unit 210 may convert sound and electrical signals into each other. To this end, the audio input/output unit 210 may include at least one of a speaker, a microphone, or a circuit for controlling them.

The camera module 212 collects data for generating images and videos. To this end, the camera module 212 may include at least one of a lens, a lens driving circuit, an image sensor, a flash, or an image processing circuit. The camera module 212 may collect light through the lens and generate data expressing color values and luminance values of light using the image sensor.

The memory 214 may store an operating system, programs, applications, commands, setting information and the like necessary to operate the client device. The memory 214 may temporarily or non-temporarily store data. The memory 214 may include a volatile memory, a non-volatile memory, or a combination of the volatile and non-volatile memory.

The power supply unit 216 supplies power necessary for the operation of components of the client device. To this end, the power supply unit 216 may include a converter circuit that converts power into power with a magnitude required by each component. The power supply unit 216 may depend on an external power source or may include a battery. In the case of including the battery, the power supply unit 216 may further include a circuit for charging. The circuit for charging may support wired charging or wireless charging.

The external connection terminal 218 is a physical connection unit for connecting the client device to another device. For example, the external connection terminal 218 may include at least one of terminals of various standards, such as a universal serial bus (USB) terminal, an audio terminal, a high definition multimedia interface (HDMI) terminal, a recommended standard-232 (RS-232) terminal, an infrared terminal, an optical terminal, or a power terminal.

The processor 220 controls the overall operation of the client device. The processor 220 may control operations of other components and perform various functions using other components. For example, the processor 220 may request content data from the server through the communication unit 206 and receive the content data. Also, the processor 220 may restore content by decoding the received content data. Also, the processor 220 may output content received from the server through the display 202 and the audio input/output unit 210. In addition, the processor 220 may control a state related to reproduction of content based on information input or sensed by at least one of the input unit 204, the communication unit 206, the sensing unit 208, the audio input/output unit 210, the camera module 212, the power supply unit 216, and the external connection terminal 218. To this end, the processor 220 may include at least one of at least one processor, at least one microprocessor, or at least one digital signal processor (DSP). In particular, the processor 220 may control other components and perform necessary operations so that the client device operates according to various embodiments described below.

In the structure of the client device described with reference to FIG. 2, all components are illustrated as being connected to the processor 220. Although not shown in FIG. 2, at least some of the components may be connected through a bus. In this case, under the control of the processor 220, direct data exchange may be made between some components.

FIG. 3 illustrates a structure of a server according to an embodiment of the present disclosure. FIG. 3 exemplifies a block structure of a server (the server 120 of FIG. 1).

Referring to FIG. 3, the server includes a communication unit 302, a memory 304, and a processor 308. However, according to various embodiments, at least one of the components illustrates in FIG. 3 may be omitted.

The communication unit 302 provides an interface for communication between the server and another device. To this end, the communication unit 302 may include a circuit that generates and analyzes a physical signal for communication. The interface provided by the communication unit 302 may support wired communication or wireless communication.

The memory 304 may store various types of information, an order and/or information and load a computer program, an instruction, and the like stored in the storage 306. The memory 304 may temporarily store data and an instruction for an operation of the server and include a random access memory (RAM). Alternatively, the memory 304 may include various storage media.

The storage 306 may non-temporarily store an operation system for operating the server, a program for performing a function of the server, setting information for an operation of the server, and the like. For example, the storage 306 may include at least one of a non-volatile memory such as a read only memory (ROM), an erasable programmable ROM (EPROM), an electrically erasable programmable ROM (EEPROM), and a flash memory, a hard disk, a removable disc, a solid state drive (SSD), or any form of computer-readable recording medium widely known in the art to which the present disclosure belongs.

The processor 308 controls an overall operation of the server. The processor 308 may control operations of other components and perform various functions using other components. The processor 308 may include at least one of a central processing unit (CPU), a micro processor unit (MPU), a micro controller unit (MCU), or a well-known form of processor in the art to which the present disclosure belongs. Particularly, the processor 308 may control other components to enable the server to operate according to various embodiments described below and perform a necessary operation.

In a structure of the server described with reference to FIG. 3, components are exemplified to be all connected to the processor 308. Although not illustrated in FIG. 3, at least a part of the components may be connected through a bus. In this case, according to control of the processor 308, direct data exchange among some components may be made.

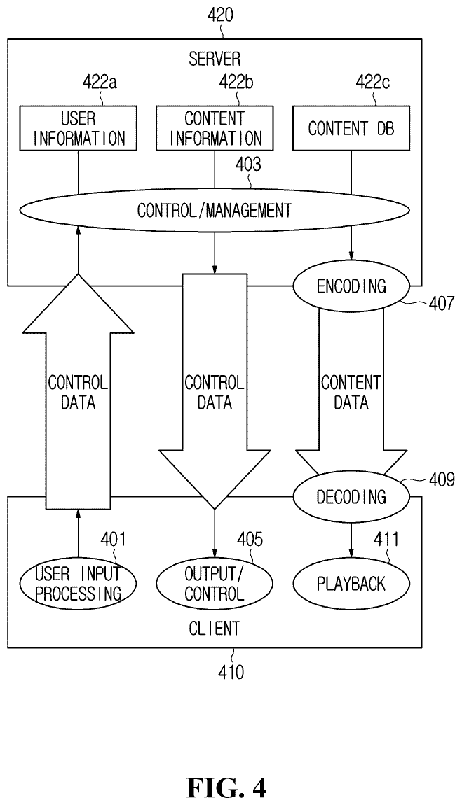

FIG. 4 illustrates a concept of a content streaming service according to an embodiment of the present disclosure. FIG. 4 is a schematic diagram of some functions related to content streaming, and a content streaming service according to various embodiments may have various other functions in addition to the functions illustrated in FIG. 4.

Referring to FIG. 4, control data and content data may be transmitted and received between the client 410 and the server 420. Specifically, transmission of control data from the client 410 to the server 420, transmission of control data from the server 420 to the client 410, and transmission of content data from the server 420 to the client 410 may be performed.

The server 420 stores user information 422a, content information 422b, and content database (DB) 422c. The user information 422a may include user account information, service use history information of users, information about user preferences, and the like. The content information 422b may include a list of serviceable content, content guide information, content meta information, and content consumption history information. The content DB 422c may include content stored in the form of data. In addition to this, the server 420 may further store other information required to provide services.

Control data transmitted from the client 410 to the server 420 may include information on user log-in, information on content selection by the user, information on control of content by the user, and the like. To this end, the client 410 may generate control data from user input through a user input processing operation 401 and transmit it. Control data from the client 410 is processed through a control/management operation 403 and used to provide content. For example, control data and/or content may be selected based on the control data from the client 401 by the control/management operation 403. In addition, preference may be determined by analyzing consumption history and behavior of the user by the control/management operation 403, and content to be recommended may be selected according to the determined preference.

A procedure for providing content to a user will be described with reference to FIG. 4 as follows. First, the client 410 generates control data including log-in information (e.g., ID and password) input by a user through the user input processing operation 401 and transmits the control data. The server 420 determines whether the user is valid by searching the user information 422a for log-in information included in the control data from the client 410, and determines the range of content and services allowed according to the user's authority. However, if log-in is not required or limited services that may be provided without log-in are supported, the transmission and processing of log-in information may be omitted.

Subsequently, the server 410 extracts content guide information from the content information 422b through the control/management operation 403 and transmits control data including the content guide information to the client 410. The client 410 outputs the content guide information included in the control data and confirms user's selection. The user's selection is transmitted to the server 410 as control data via the user input processing operation 401. Information about the user's selection is processed by the control/management operation 403 and used for selection of content to be streamed. The server 420 searches the content DB 422 for the selected content, compresses and segments the searched content through an encoding operation 407, and transmits content data. The content data may be compressed in advance through the encoding operation 407 and stored. Here, the encoding operation 407 may include not only an operation of compressing an original content image, but also an operation of decoding and then re-compressing content data generated through compression. In this case, compression may be performed based on the resolution, bitrate, and number of frames per second of the content image. When it is compressed and stored in advance, the compression operation is omitted, and the server 420 may perform segmentation on the content data. The content data may be restored through a decoding operation 409 and provided to a user through a playback operation 411. At this time, at least one of various video codecs or various audio codecs may be used for compression. For example, various video codecs include at least one of Moving Picture Experts Group-2 (MPEG-2), H.264 Advanced Video Coding (AVC), H.265 High Efficiency Video Coding (HEVC), H.266 Versatile video coding (VVC), VP8 (Video Processor 8), VP9 (Video Processor 9), AV1 (AOMedia Video 1), DivX, Xvid, VC-1, or Daala.

The audio codecs may include MP3 (MPEG 1 Audio Layer 3), AC3 (Dolby Digital AC-3), E-AC3 (Enhanced AC-3), AAC (Advanced Audio Coding, MPEG 2 Audio), FLAC (Free Lossless Audio Codec), HE-AAC (High Efficiency Advanced Audio Coding), OGG Vorbis, OPUS and the like.

A plurality of content data may be generated in advance by compressing a content image according to various resolutions, bitrates, and the number of frames per second of the image. The client 310 may measure throughput (or bandwidth) and determine a bitrate based on the measured throughput (or bandwidth).

The client 410 may receive information about a plurality of content data from the server 420. The received information may include information representing the bitrate, resolution, number of frames per second, and location of a plurality of content data.

The client 410 may determine at least one of content data based on the bitrate, and determine reproduced content data corresponding to the resolution and number of frames per second that may be reproduced among the at least one content data based on the capability information of the client 410, and its location. In this case, the capability information may include the maximum support resolution and the maximum number of supported frames of the client, but is not limited thereto.

The client 410 may transmit a content request to the server 420 based on the location of reproduced content data. The server 420 may transmit content data corresponding to the content request to the client 410 based on the received content request.

According to another embodiment, the client 410 may receive user input related to at least one of the resolution or number of frames per second of the image, determine content data to be reproduced and its location according to the user input, and transmit the content request to the server 420.

The present disclosure relates to a technology for searching for content in a content streaming system by a language model trained based on text-form metadata (hereinafter referred to as “text metadata”) that describes the content itself. Specifically, the present disclosure relates to a method and device for determining similarity between a search term and content by using a language model trained based on text metadata of the content and for generating a content search list based on the similarity between the search term and the content. Herein, the text metadata may include at least one of a title, a synopsis, a genre, a director, an actor, or a hashtag. A language model may be a content-based filtering (CBF) model that processes a natural language. For example, a language model may be a transformer model that is a natural language processing model for quantifying, that is, embedding, text metadata of content so that a computer can understand it. For example, a transformer-based model may include, but is not limited to, BERT (Bidirectional Encoder Representations from Transformers), ELECTRA (Efficiently Learning an Encoder that Classifies Token Replacements Accurately), RoBERTa (Robustly Optimized BERT Approach), BART (Bidirectional Auto-Regressive Transformer), GPT-3 (Generative Pre-trained Transformer), DeBERTa (Decoding-Enhanced BERT with Disentangled Attention), and KLUE (Korean Language Understanding Evaluation)-RoBERTa-large models.

Before describing a specific method for searching for content through a language model, the present disclosure will describe the basic concepts of natural language processing and the RoBERTa model to aid understanding of the CBF model.

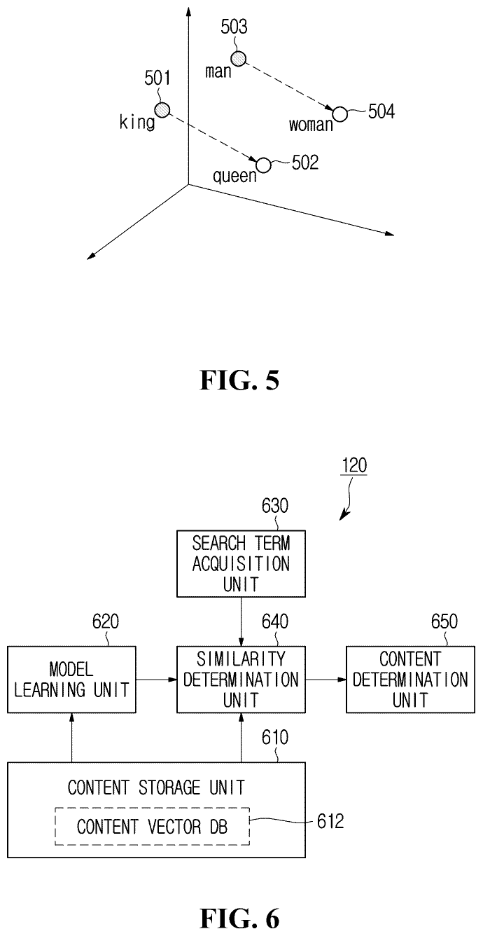

In order to determine similarity between a search term and content based on a CBF model, it is necessary to quantify text metadata of the content, which is composed of natural language or unstructured data, into data that can be understood by a computer. At this time, the technology of digitizing, i.e., vectorizing, natural language, unstructured data into data that a computer can understand is called embedding. Natural language, unstructured data may be expressed as vectors through embedding, and the vectors may be mapped to a vector space, as illustrated in FIG. 5. At this time, the distance and/or direction between vectors may be interpreted as information on a relative relationship between vectors. FIG. 5 illustrates an example of a relative relationship between vectors. For example, if a vector 501 representing a king is referred to as v1, a vector 502 representing a queen is referred to as v2, a vector 503 representing a man is referred to as v3, and a vector 504 representing a woman is referred to as v4 in FIG. 5, then since king and queen, and man and woman have similar meanings related to gender, the distances (v1, v2) and (v3, v4) may be similar, and the directions (v1, v2) and (v3, v4) may be similar. On the other hand, although not shown in FIG. 5, if a vector representing a computer is referred to as v5, the distance (v1, v5) will be further than the distance (v1, v2), and the directions (v1, v5) and (v1, v2) will be different. In this manner, the relative similarity between vectors may be determined. In the example of FIG. 5, the embedding size, which is the length of the vector, is set to three dimensions, but the embedding size in an actual CBF model may be set to a higher multidimensionality. This is because when a vector has a multidimensional embedding size, it may include more complex meanings.

In a CBF model that represents content as vectors, it is important to ensure that the vectors accurately capture the semantic information of the content. It is because similarity between a search term and content can be accurately determined only when a vector accurately represents the semantic information of the content. Therefore, according to embodiments of the present disclosure, in order to express the content as a vector having accurate semantic information, the system will fine-tune the language model of the CBF model by training the language model. Specifically, in various embodiments of the present disclosure, the language model may be trained to convert an input text sequence including meta information such as a title, synopsis, etc. of each content into a vector having accurate semantic information.

The language model is a model that has the ability to vectorize input text, and may be divided into a word-level embedding model and a sentence or document-level embedding model. The word-level embedding model is a model that assigns the same vector to words with the same form, for example, a word2vec model. The sentence-level embedding model is a model that distinguishes each word by considering context information, for example, a BERT model.

To examine the difference between the word-level embedding model and the sentence-level embedding model, assume an input text sequence, “The snow falling on a winter night is beautiful.” In the case of the word-level embedding model, the “snow” in the input text sequence and the “eye” which is a human body part are expressed by the same vector. On the other hand, in the case of the sentence-level embedding model, by utilizing the context information of the entire input text sequence, the “snow” in the input text sequence and the “eye” which is a human body part may be expressed by different vectors. In this way, the sentence-level embedding model may express the input text sequence as a vector including more correct semantic information than the word-level embedding model. Therefore, according to one embodiment, RoBERTa, which is one of the sentence-level embedding models, may be used.

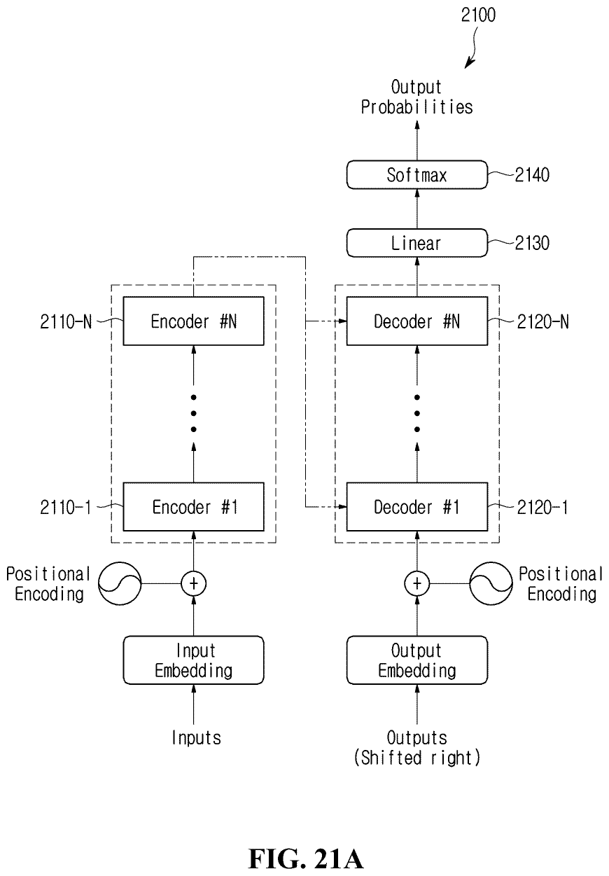

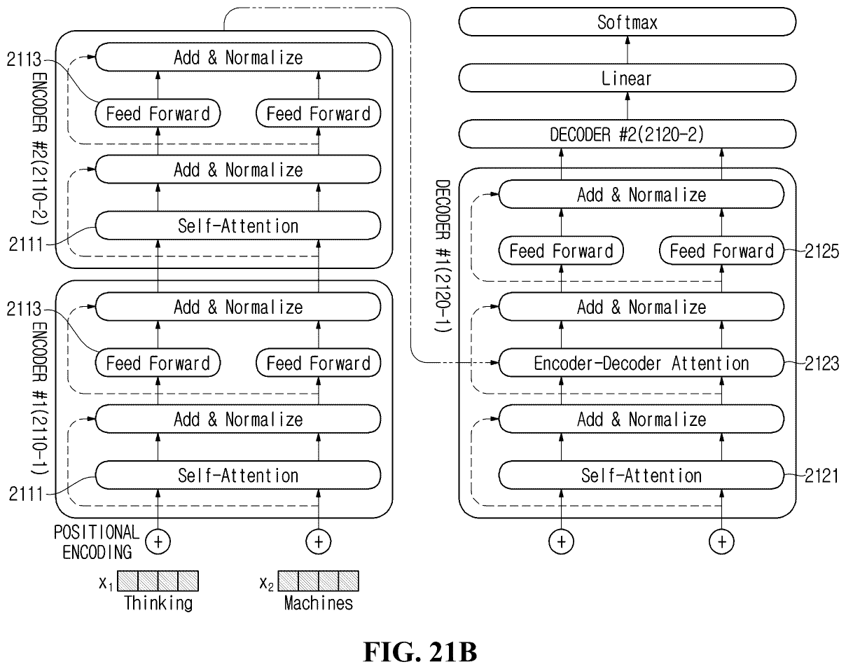

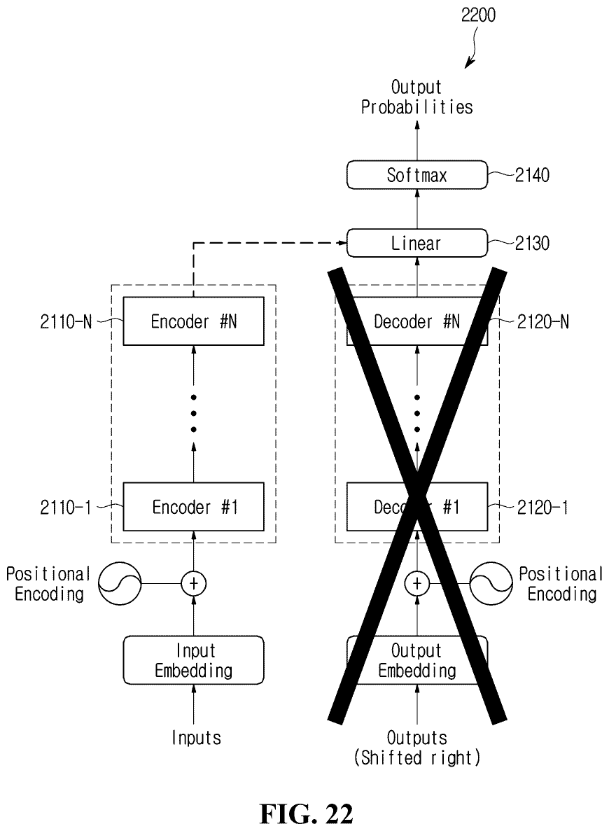

The RoBERTa model is a model developed from the BERT model. The BERT model is the predecessor of the RoBERTa model and is a language model that has pre-trained a large amount of text data through unsupervised learning. The BERT model has a structure in which encoder blocks of the transformer structure are stacked in multiple layers, and is pre-trained using a masked language model (MLM) method and a next sentence prediction (NSP) method. The architecture of a transformer and that of a BERT model will be described in detail below with reference to FIG. 21A, FIG. 21B and FIG. 22.

The MLM method is a method that predicts randomly masked words, and the NSP method is a method that predicts whether two sentences may appear consecutively in context. The BERT model has a structure that learns text in both directions, so it has the advantage of obtaining better semantic representation information compared to models with a unidirectional structure.

RoBERTa is a model trained after adding learning data and adjusting hyper parameters and training techniques to enhance the performance of the BERT model. The RoBERTa model may be trained only with the MLM method, excluding the NSP method. The RoBERTa model has been improved to undergo longer training with larger learning data and longer sequences than the BERT model, and to obtain more sophisticated semantic representation information by applying dynamic masking. In other words, RoBERTa has been improved to have better performance than the GLUE (general language understanding evaluation) benchmark performance of previous models including BERT.

Accordingly, a system according to embodiments of the present disclosure may use the RoBERTa model, which is a pre-trained natural language processing model based on a Korean language corpus, to search for content. However, the language model in the embodiments described below is not necessarily limited to the RoBERTa model, and may be applied even when a language model other than RoBERTa is used.

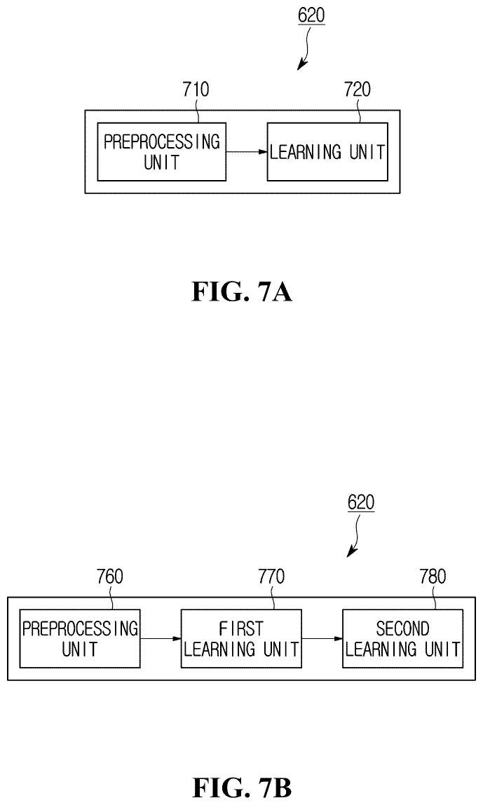

FIG. 6 illustrates an example of the structure of a server that searches for content according to an embodiment of the present disclosure. At least some components of the server illustrated in FIG. 6 (e.g., the server 120 of FIG. 1) may be construed as components included in the processor 308 of FIG. 3. Hereinafter, at least some components of FIG. 6 will be described with reference to FIG. 7A to FIG. 11.

Referring to FIG. 6, the server 120 may include a content storage unit 610, a model learning unit 620, a search term acquisition unit 630, a similarity determination unit 640, and a content determination unit 650.

The content storage unit 610 stores content items that may be provided to clients. The content items include movie content, drama content, and program content that may be streamed, and one content item corresponds to one movie, one drama, or one program. For example, a first content item and a second content item may correspond to different movies. However, according to another embodiment, the content storage unit 610 may exist outside the server 120, and in this case, the server 120 may access the external content storage unit 610 and search for and obtain content items.

According to one embodiment, the content storage unit 610 may include a content vector DB 612. The content vector DB 612 stores the vector value of each of the content items stored in the content storage unit 610. The vector value of each of the content items may be obtained using a language model trained by the model learning unit 620. The content vector DB 612 may be updated by the updated language model when the language model is updated. For example, the language model may be updated by being retrained when a new content item is stored in the content storage unit 610 or when a previously stored content item is deleted. That is, the content vector DB 612 may obtain and store the vector value of each of the content items using the updated language model when the language model is retrained and updated. At this time, the vector value of each of the previously stored content items may be deleted.

According to one embodiment, the content vector DB 612 may be updated automatically periodically or when a specified event occurs, or may be updated under the control of a business operator and/or an administrator. For example, when a new content item is stored in the content storage unit 610, the content vector DB 612 may be updated to additionally store the vector value of the new content item. As another example, when a content item previously stored in the content storage unit 610 is deleted, the content vector DB 612 may be updated to delete the vector value of the deleted content item.

The model learning unit 620 performs learning for a language model based on text metadata that describes content of a content item. Text metadata means a text feature describing content of a content item. The text metadata may include at least one of the title, synopsis, composite genre, director, actor, and hashtag information of the content item. Here, the composite genre may include at least one of a major category genre or a minor category genre. For example, the minor category genre of the major category genre ‘action/SF’ may be classified into ‘action’, ‘fantasy’, ‘SF’, ‘adventure’, ‘war’, ‘martial arts’, etc. The hashtag information refers to tag information indicating at least one of the topic, emotion, or purpose of the content item. The synopsis refers to overview information indicating at least one of the topic, planning intention, or plot of the content item.

According to one embodiment, the model learning unit 620 may include a preprocessing unit 710 and a learning unit 720, as illustrated in FIG. 7A, or may include a preprocessing unit 760, a first learning unit 770, and a second learning unit 780, as illustrated in FIG. 7B.

First, referring to FIG. 7A, the preprocessing unit 710 of the model learning unit 620 obtains text metadata of a content item for learning a language model, and converts the obtained text metadata into sequence-type text data. The sequence-type text data refers to data in the form of a string in which text data are continuously connected. The preprocessing unit 710 converts text metadata into sequence-type text data because text data that is classified as structured data, such as metadata of a content item, cannot be directly input into a language model. Therefore, the preprocessing unit 710 may convert the text metadata into sequence-type text data by dividing the text metadata of a content item into token units and then inserting at least one separator. Here, a token refers to an input unit of a language model that is replaced with a unique embedding value, and at least one separator that is inserted may also be treated as a token. At least one separator may include at least one of a separator token (e.g., [SEP]) for separating different types of features, and special tokens representing specific features. The special tokens may include at least one of special tokens [GENRE] and [/GENRE] representing a genre, special tokens [DIR] and [/DIR] representing a director, special tokens [ATR] and [/ATR] representing an actor, and special tokens [TAG] and [/TAG] representing a hashtag. The listed special tokens are only examples to help understanding, and the embodiments of the present disclosure are not limited thereto. Each special token may be inserted before or after the text corresponding to the feature. The reason why the special token is used in the present disclosure is because various types of features are included in the text metadata of the content item. That is, it may be difficult for the language model to recognize various types of features only with the separator tokens and/or the order of the separator tokens included in the input sequence. The special token may be added to the vocabulary of the language model.

According to one embodiment, the preprocessing unit 710 may convert text metadata including an identification code, title, genre, director, actor, hashtag, and synopsis of a content item into sequence-type text data including separators as shown in [Table 1] below.

TABLE 1
Title [SEP] Synopsis Token 1 Synopsis Token 2 . . . Synopsis Token N
[GENRE] Genre 1 Genre 2 [/GENRE] [DIR] Director [/DIR] [ATR]
Actor 1 Actor 2 [/ATR] [TAG] Tag 1 Tag 2 [/TAG]

In [Table 1], Synopsis Token 1, Synopsis Token 2, and Synopsis Token N each represent different tokens included in the synopsis of the corresponding content item.

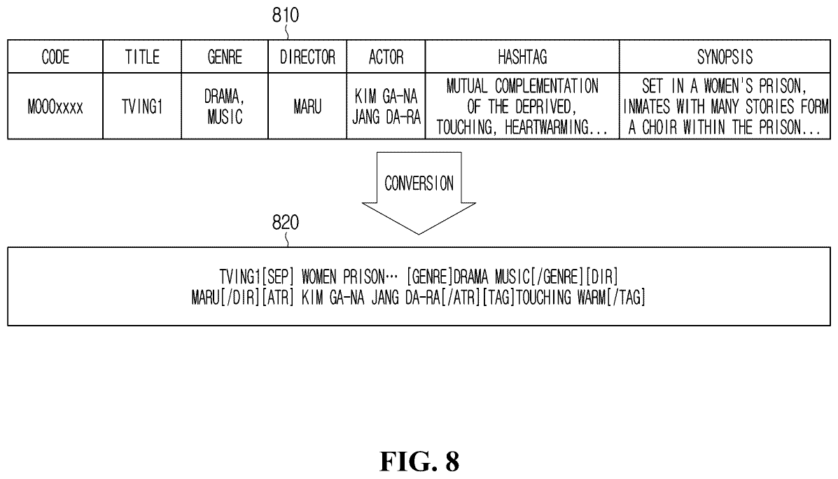

As a specific example, the preprocessing unit 710 may generate sequence-type text data as illustrated in FIG. 8. FIG. 8 illustrates an example of converting text metadata of content into sequence-type text data according to an embodiment of the present disclosure. Referring to FIG. 8, the preprocessing unit 710 may convert text metadata of content into sequence-type text data 820 by adding a separator token and special tokens to text metadata 810 of a content item. At this time, if the content item has a plurality of directors and/or actors, the preprocessing unit 710 may limit the number of directors and/or actors included in the sequence-type text data. For example, the number of directors and/or actors may be limited to a maximum of five or fewer, but the present disclosure is not limited thereto. The preprocessing unit 710 provides generated sequence-type text data to the learning unit 720.

The learning unit 720 of the model learning unit 620 performs learning on a language model based on sequence-type text data. That is, the learning unit 720 may perform learning on a language model by performing training on a prediction model based on a specific type of information among the sequence-type text data obtained by the preprocessing unit 710. The specific type of information may include hashtag information, genre information, or synopsis information. Specifically, the learning unit 720 may perform any one of the first to third embodiments below.

### First Embodiment

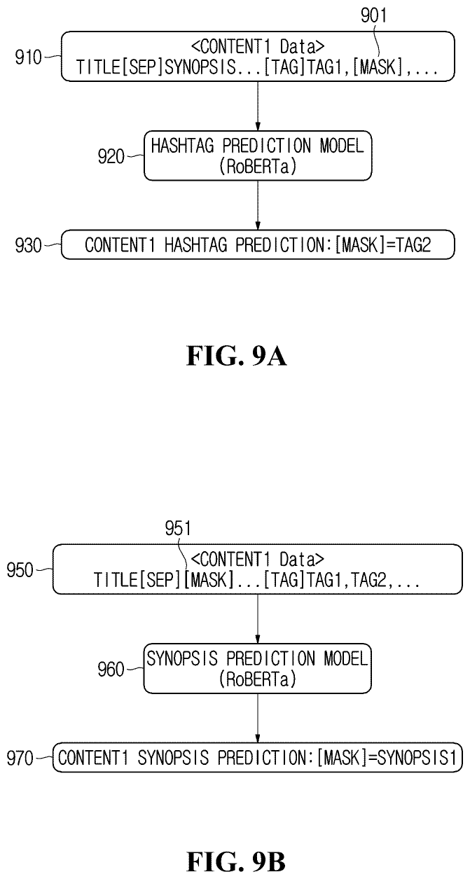

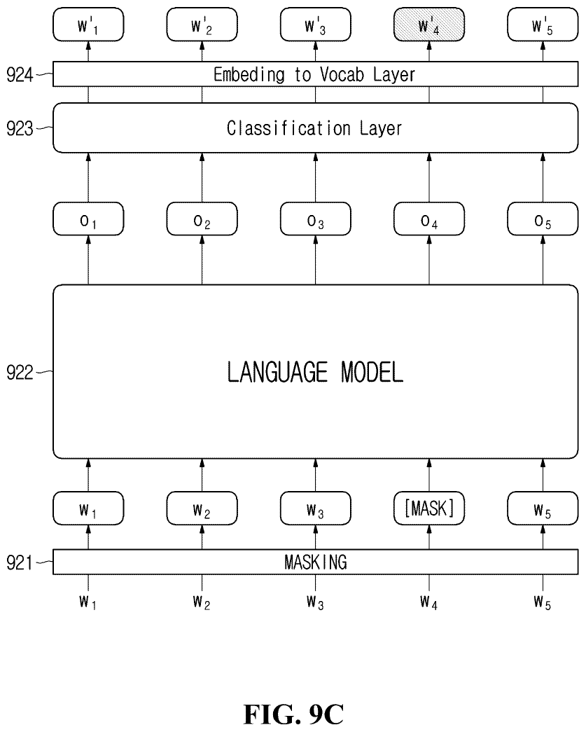

According to the first embodiment, the learning unit 720 may perform learning on a language model by training a prediction model based on hashtag information in sequence-type text data. Here, the prediction model may include a hashtag prediction model, which is a prediction model of an MLM method configured to predict or infer masked hashtag tokens based on a language model. For example, the learning unit 720 may perform learning on a language model as illustrated in FIG. 9A. FIG. 9A illustrates an example of learning of a language model according to an embodiment of the present disclosure.

Referring to FIG. 9A, the learning unit 720 may mask one token (e.g., ‘Tag 2’) corresponding to a hashtag among tokens included in the sequence-type text data, and define the value of the masked token as a label. The learning unit 720 may input text data 910 including the masked token 901 to the hashtag prediction model 920, determine a loss value using the output value and the label, and perform backpropagation based on the loss value, thereby performing training and/or learning for the hashtag prediction model 920. Accordingly, the hashtag prediction model 920 may be trained and/or learn to predict 930 and/or infer the value of the masked token 901. At this time, the hashtag prediction model 920 may be trained or learn to obtain context information from other unmasked tokens and infer a masked token, i.e., a token corresponding to a hashtag, based on the obtained context information. For example, the hashtag prediction model 920 may be trained based on context information obtained from unmasked tokens, such as a title, a synopsis, etc. In this way, the input and target for the learning task of the hashtag prediction model 920 based on a language model may be expressed as shown in [Table 2] below.

TABLE 2

| Prediction | Input | Target |
|---|---|---|
| Hashtag | Title [SEP] Synopsis Token 1 Synopsis Token | [MASK] = |
| prediction | 2 . . . Synopsis Token N [GENRE] Genre 1 | Tag 2 |
| | Genre 2 [/GENRE] [DIR] Director [/DIR] | |
| | [ATR] Actor 1 Actor 2 [/ATR] [TAG] Tag 1 | |
| | [MASK] [/TAG] | |

[Table 2] shows that when the token of ‘Tag 2’ among a plurality of tokens located in a hashtag area is masked and input to the hashtag prediction model 920, the hashtag prediction model 920 is trained to infer the token of ‘Tag 2’. Here, the reason why only one token is masked even though there are a plurality of tokens in the hashtag area is because, when two or more tokens are masked, it is not easy for the language model to identify the positional relationship between the masking tokens included in the input and the target tokens. Therefore, the learning unit 720 according to the first embodiment may operate in a manner of masking and inferring one token in the hashtag area, and then masking and inferring another token in the hashtag area. For example, the token masked in the hashtag area may vary from epoch to epoch. According to the first embodiment, the learning unit 720 may mask tokens that do not start with ‘#’, i.e., non-dependent tokens, among tokens located in the hashtag area. The hashtag area may be determined based on special tokens [TAG] and [/TAG] representing hashtags.

### Second Embodiment

According to the second embodiment, the learning unit 720 may perform learning on the language model by training the prediction model based on the synopsis information in the sequence-type text data. Here, the prediction model may include a synopsis prediction model, which is a prediction model of the MLM method configured to predict or infer masked synopsis tokens based on the language model. For example, the learning unit 720 may perform learning on the language model as illustrated in FIG. 9B. FIG. 9B illustrates an example of learning a language model according to an embodiment of the present disclosure.

Referring to FIG. 9B, the learning unit 720 may mask one token (e.g., ‘Synopsis Token 1’) corresponding to the synopsis among the tokens included in the sequence-type text data, and define the value of the masked token as a label. The learning unit 720 may input text data 950 including a masked token 951 to a synopsis prediction model 960, determine a loss value using the output value and the label, and perform backpropagation based on the loss value, thereby performing training and/or learning for the synopsis prediction model 960. Accordingly, the synopsis prediction model 960 may be trained and/or learn to predict 970 and/or infer the value of the masked token 951. At this time, the synopsis prediction model 960 may be trained or learn to obtain context information from other unmasked tokens and infer a masked token, i.e., a token corresponding to a synopsis, based on the obtained context information. For example, the synopsis prediction model 960 may be trained based on context information obtained from unmasked tokens, such as a title, a genre, a hashtag, etc. In this way, the input and target for the learning task of the synopsis prediction model based on a language model may be expressed as shown in [Table 3] below.

TABLE 3

| Prediction | Input | Target |
|---|---|---|
| Synopsis | Title [SEP] [MASK] Synopsis Token2 . . . | [MASK] = |
| prediction | Synopsis TokenN [GENRE] Genre1 | Synopsis |
| | Genre2 [/GENRE] [DIR] Director [/DIR] | Token 1 |
| | [ATR] Actor1 Actor2 [/ATR] [TAG] | |
| | Tag1 Tag2 [/TAG] | |

[Table 3] shows that when the token of ‘Synopsis Token 1’ among the plurality of tokens located in the synopsis area is masked and input to the synopsis prediction model 960, the synopsis prediction model 960 is trained to infer the token of ‘Synopsis Token 1’. Here, the reason why only one token is masked even though there are the plurality of tokens in the synopsis area is because it is not easy for the language model to identify the positional relationship between the masking tokens included in the input and the target tokens when two or more tokens are masked. Therefore, the learning unit 720 according to the second embodiment may operate in a manner of masking and inferring one token in the synopsis area, and then masking and inferring another token in the synopsis area. For example, the token masked in the synopsis area may vary from epoch to epoch. The learning unit 720 according to the second embodiment is not limited to masking and inferring tokens of the synopsis area, and may also mask and infer tokens of the title area. For example, the learning unit 730 may mask and infer tokens of the title area in addition to the synopsis area. Alternatively, the learning unit 730 may mask and infer tokens of the title area instead of the synopsis area.

According to the second embodiment, the learning unit 720 may mask tokens that do not start with ‘#’, i.e., non-dependent tokens, among tokens located in the synopsis area. The synopsis area may be determined based on a separator token and/or a special token. For example, the synopsis area may be determined as an area between a separator token [SEP] and a special token [GENRE] for a genre. However, this is only an example for a case where text metadata of a content item is converted into sequence-type text data as in [Table 1], and the method of determining the synopsis area is not limited thereto. For example, if the sequence-type text data is composed of “Title[SEP] Director[SYNOPSIS] Synopsis Token1 Synopsis Token2 . . . Synopsis TokenN[/SYNOPSIS][GENRE]Genre1 Genre2 [/GENRE][ATR]Actor1 Actor2[/ATR][TAG]Tag1 Tag2[/TAG]”, the synopsis area may be determined to be an area between [SYNOPSIS] and [/SYNOPSIS], which are special tokens representing the synopsis. In other words, the synopsis area may vary depending on the method of configuring the sequence-type text data.

In the first and second embodiments described above, the reason why tokens that do not start with ‘#’ are masked is because, due to the characteristics of the BPE (Byte Pair Encoding) tokenizer of the RoBERTa model, tokens that start with “#” are dependent on the preceding token or are tokens with grammatical meaning. In other words, tokens that relatively include core meanings such as nouns and verbs do not start with ‘#’, so the learning unit 720 may mask tokens that do not start with ‘#’ among the tokens located in the synopsis area. For example, when the BPE tokenizer divides a text sentence into token units, it may divide “Mr. XX is working at an interesting OTT field, Tving” into “#Mr.+XX+#is+work+#-ing+ #at+#an+interest+#-ing+OTT+field+#, +Tving”. As in the example above, the tokenizer may indicate that a token is dependent on a preceding token by adding ‘#’ to the dependent token.

The way to indicate a dependent token is not limited to the way of adding ‘#’ to the token. For example, in the case of other tokenizers, ‘##’ or ‘_’ may be added to the dependent token, and various other ways may be used to indicate that the token is a dependent token. Therefore, the form of the dependent token is not limited to a specific form, and the learning unit 720 may mask tokens that are not dependent tokens.

According to one embodiment, the hashtag prediction model 920 and/or the synopsis prediction model 960 may include, as illustrated in FIG. 9C, a masking block 921 that masks at least one token among a plurality of input tokens (e.g., [W₁, W₂, W₃, W4, W₅]), a language model 922 that outputs vector values (e.g., [O₁, O₂, O₃, O₄, O₅]) corresponding to the plurality of input tokens (e.g., [W₁, W₂, W₃, [MASK], W₅]) including masked tokens, a classification layer 923 that infers vector values of the masked tokens from vector values output from the language model, and an embedding to vocabulary layer 924 that converts the vector values into tokens. Here, the language model 922 may include a RoBERTa model. In addition, the classification layer 923 may include a fully connected layer, a Gaussian error linear unit (GELU), and a norm, and may be referred to as an MLM head layer. The classification layer 923 may output prediction tokens (e.g., [W′₁, W′₂, W′₃, W′₄, W′₅]) corresponding to the plurality of input vector values (e.g., [O₁, O₂, O₃, O₄, O₅]). The prediction model 920 may be trained to predict and/or infer a masked token (e.g., W4) that is appropriate for the content and does not overlap with the unmasked tokens, based on context information from the unmasked tokens (e.g., [W₁, W₂, W₃, W₅]), i.e., the target.

### Third Embodiment

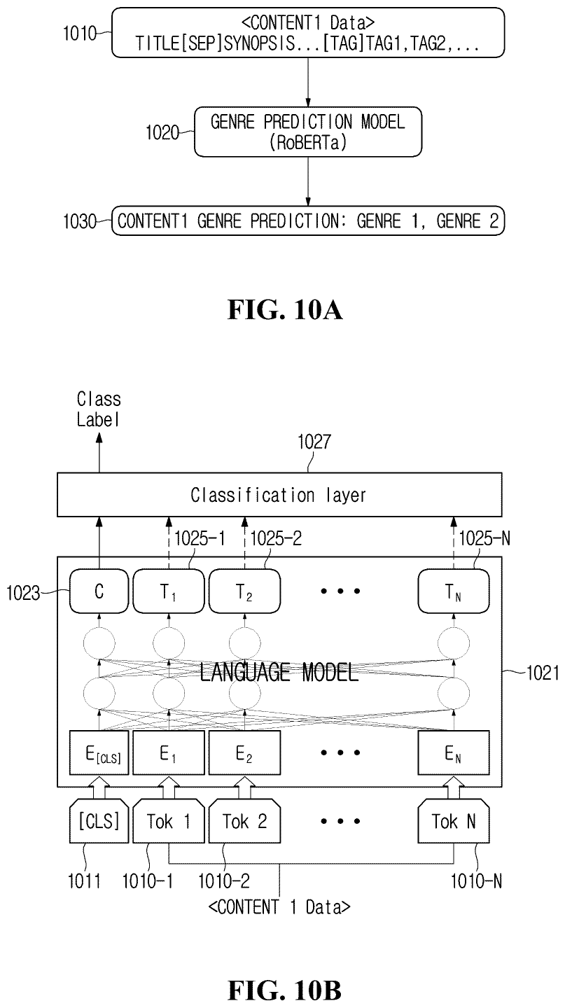

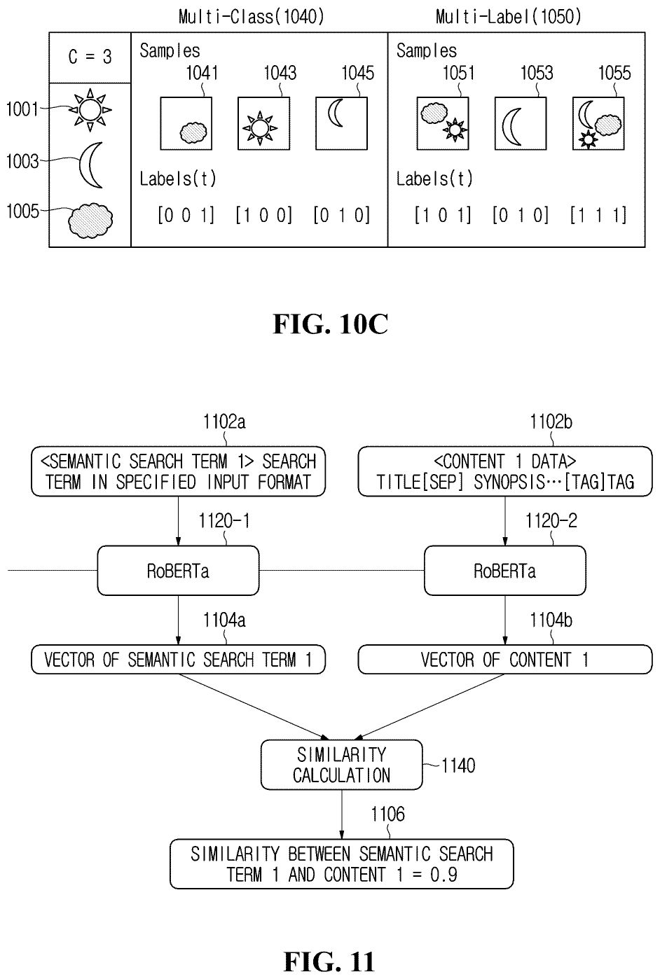

According to the third embodiment, the learning unit 720 may perform learning on a language model by training a prediction model based on genre information in sequence-type text data. At this time, the prediction model may include a genre prediction model, which is a prediction model of a text classification method configured to predict or infer genres for content items based on a language model. For example, the learning unit 720 may perform learning on a language model as illustrated in FIG. 10A. FIG. 10A illustrates an example of learning of a language model according to an embodiment of the present disclosure.

Referring to FIG. 10A, the learning unit 720 obtains input sequence-type text data that does not include genre-related tokens, and performs a text classification task using a genre prediction model 1020, thereby predicting a genre to which a content item having the input sequence-type text data belongs. The text classification task refers to a task of distinguishing which class a text input to a prediction model belongs to. Here, the input sequence-type text data may be generated by removing genre-related tokens from the sequence-type text data. The genre-related tokens may include special tokens [GENRE] and [/GENRE] representing a genre, and tokens corresponding to genre information (hereinafter, “genre tokens”). The genre tokens are located in a genre area between special tokens [GENRE] and [/GENRE] representing a genre, and may include at least one token representing a genre. For example, a genre token expressing a genre called ‘horror/thriller’ may include three tokens called ‘horror’, ‘/’, and ‘thriller’, and a genre token expressing a genre called ‘drama’ may include one token called ‘drama’. The input sequence-type text data may be generated in the preprocessing unit 710 or the learning unit 720.

Specifically, the learning unit 720 may obtain at least one token representing at least one genre from the sequence-type text data, and set a class label based on the obtained at least one token. Here, one genre can be expressed by one or more tokens. For example, the genre “horror/thriller” may be expressed by three tokens “horror”, “/”, and “thriller”, and the genre “drama” may be expressed by one token “drama”. Therefore, when one or more tokens representing one genre are obtained from the sequence-type text data, the learning unit 720 may set a class label to predict one genre based on the obtained one or more tokens. In addition, when a plurality of tokens representing a plurality of genres are obtained from the sequence-type text data, the learning unit 720 may set a class label to predict a plurality of genres based on the obtained plurality of tokens. The learning unit 720 may use a multi-class classification model or a multi-label classification model depending on the number of genres to be predicted, which will be described later in FIG. 10C.

The learning unit 720 inputs input sequence-type text data 1010 that does not include a genre-related token to a genre prediction model 1020, determines a loss value (e.g., cross entropy) using the output value of the genre prediction model 1020 and a preset class label, and performs backpropagation based on the loss value, thereby performing training and/or learning on the genre prediction model 1020. Accordingly, the genre prediction model 1020 may be trained and/or learn to predict 1030 and/or infer at least one genre set as a class label from the input sequence-type text data 1010.

According to the third embodiment, the genre prediction model 1020 may include, as illustrated in FIG. 10B, a language model 1021 that outputs vector values (e.g., [C, T₁, T₂, . . . , T_{N}]) corresponding to input tokens (e.g., [CLS, Tok1, Tok2, . . . , TokN]), and a classification layer 1027 that outputs a probability value of a class label based on at least one vector value output from the language model 1021. Here, the language model 1021 may include a RoBERTa model. In addition, the classification layer 1027 may be referred to as a text classification layer, and/or a text classification head layer.

As illustrated in FIG. 10B, the learning unit 720 may obtain a genre prediction result for the corresponding content from the prediction model 1020 by inputting input sequence-type text data 1010 that does not include a genre-related token to the prediction model 1020. At this time, the input sequence-type text data 1010 may include a plurality of tokens Tok1 1010-1, Tok2 1010-2, . . . , TokN 1010-N. The learning unit 720 may add a start token, [CLS] 1011, to the start position of the input sequence-type text data 1010 and input it to the language model 1021. The language model 1021 may output the last hidden vector C 1023 corresponding to the start token [CLS] 1011, and the last hidden vectors T₁ 1025-1, T₂ 1025-2, . . . , T_{N} 1025-N corresponding to the plurality of tokens Tok1 1010-1, Tok2 1010-2, . . . , TokN 1010-N. The last hidden vector C 1023 may be an output vector that reflects context information of the entire plurality of tokens Tok1 1010-1, Tok2 1010-2, . . . , TokN 1010-N included in the input sequence-type text data 1010. The last hidden vector C 1023 is input to the classification layer 1027, and the classification layer 1027 may output the probability value of the class label based on the last hidden vector C 1023. The learning unit 1020 may predict the class to which the corresponding content belongs, i.e., the genre, based on the output probability value of the class label. According to one embodiment, the classification layer 1027 may use only the last hidden vector C 1023 as input, or may use the last hidden vector C 1023 and other last hidden vectors T₁ 1025-1, T₂ 1025-2, . . . , T_{N} 1025-N as input together. For example, the classification layer 1027 may receive the average pooling of the last hidden vectors T₁ 1025-1, T₂ 1025-2, . . . , T_{N} 1025-N output from the language model 1021 and output the probability value of the class label based on this.

As described above, the genre prediction model 1020 may be trained or learn to obtain context information from all tokens included in the input sequence-type text data 1010 and infer the genre based on the obtained context information. For example, the genre prediction model 1020 may be trained based on context information obtained from tokens such as a title, synopsis, hashtags, etc. In this way, the input and target for the learning task of the genre prediction model based on the language model may be represented as shown in [Table 4] below.

TABLE 4

| Prediction | Input | Target |
|---|---|---|
| Genre | Title [SEP] Synopsis Token 1 Synopsis | Genre 1, |
| prediction | Token 2 . . . Synopsis Token N [DIR] | Genre 2 |
| | Director [/DIR] [ATR] Actor 1 Actor 2 | |
| | [/ATR] [TAG] Tag 1 Tag 2 [/TAG] | |

[Table 4] shows that when input sequence-type text data is input to the prediction model, the genre prediction model is trained to infer tokens of ‘genre 1’ and ‘genre 2’. Here, the target means a class label, and there being a plurality of targets of ‘genre 1’ and ‘genre 2’ means that the corresponding content item may belong to a plurality of genres rather than one genre. For example, a specific content item may belong to the ‘action/SF’ genre among the major category genres and the ‘fantasy’ genre among the minor genres. In general, the genres of content items may be classified into major category genres and/or minor genres. The major category genres may include drama, romance/melodrama, comedy, action/SF, horror/thriller, etc. The minor genres may include drama, action, thriller, romance, comedy, horror, fantasy, SF, crime, historical drama, war, martial arts, etc. The listed genres are only examples to help understanding, and the embodiments of the present disclosure are not limited thereto. As described above, genres of content items may be categorized in various ways, and one content item may belong to one or more genres. Accordingly, the genre prediction model according to the third embodiment may be trained to infer only one genre to which a content item belongs, or may be trained to infer one or more genres to which a content item belongs. For example, the prediction model 1020 may be trained to infer one or more genres to which a content item belongs, by including a multi-class classification model or a multi-label classification model based on a supervised learning algorithm, as illustrated in FIG. 10C.

FIG. 10C illustrates the concept of a multi-class classification model and a multi-label classification model applicable to the present disclosure. In FIG. 10C, C may mean the number of classes. That is, FIG. 10C assumes a case where there are three classes 1001, 1003 and 1005.

The multi-class classification model 1040 is a model for inferring one class to which an input sample belongs among multi-classes. Therefore, the label of the multi-class classification model 1040, i.e., the target vector t, may be set to a one-hot vector having one positive class and C−1 negative classes. For example, the label for a first input sample 1041 of the multi-class classification model 1040 may be set to [001], the label for a second input sample 1043 may be set to [100], and the label for a third input sample 1043 may be set to [010]. Here, the label is an expected output vector value for the input sample and may be set based on the class to which the input sample actually belongs. For example, a label set to [100] may mean that the corresponding input sample actually belongs to the first class 1001, but does not belong to the second class 1003 or the third class 1005, and a label set to [010] may mean that the corresponding input sample actually belongs to the second class 1003, but does not belong to the first class 1001 or the third class 1005. Additionally, a label set to [001] may mean that the corresponding input sample actually belongs to the third class 1005, but does not belong to the first class 1001 or the second class 1003.

The multi-label classification model 1050 is a model for inferring multiple classes to which an input sample belongs among multi-classes. The label of the multi-label classification model, i.e., the target vector t, may be set to a vector having multiple positive classes. For example, the label for a fourth input sample 1051 of the multi-label classification model may be set to [101], the label for a fifth input sample 1053 may be set to [010], and the label for a sixth input sample 1055 may be set to [111]. Here, the label is an expected output vector value for the input sample and may be set based on one or more classes to which the input sample actually belongs. For example, a label set to [101] may mean that the corresponding input sample actually belongs to the first class 1001 and the third class 1005, a label set to [010] may mean that the corresponding input sample actually belongs to the second class 1003, and a label set to [111] may mean that the corresponding input sample actually belongs to the first class 1001, the second class 1003, and the third class 1005.

The learning unit 720 may be trained to infer one or more genres to which each content item belongs through the genre prediction model 1020 configured based on the multi-class classification model 1040 or the multi-label classification model 1050 as illustrated in FIG. 10C. In the structure described above, the more accurately the genre prediction model infers the target, the more sophisticated the semantic representation of the language model may become.

Next, referring to FIG. 7B, the preprocessing unit 760 of the model learning unit 620 obtains text metadata of a content item for learning of a language model, and converts the obtained text metadata into sequence-type text data. That is, the preprocessing unit 760 may convert text metadata including an identification code, title, genre, director, actor, hashtag, and synopsis of a content item into sequence-type text data including separators as in [Table 1]. In other words, the preprocessing unit 760 of FIG. 7B may perform at least one operation that may be performed in the preprocessing unit 710 of FIG. 7A.

The first learning unit 770 performs primary learning on the language model using a prediction model configured to predict or infer masked tokens. The first learning unit 770 may perform primary learning on the language model by training the prediction model based on a specific type of information among the sequence-type text data of the content item obtained from the preprocessing unit 760. According to one embodiment, the first learning unit 770 may perform training on the prediction model based on hashtag information in the sequence-type text data of the content item. For example, as illustrated in FIG. 9A, the first learning unit 770 may perform primary learning for a language model based on hashtag information. That is, the first learning unit 770 may perform primary learning on the language model based on hashtag information using a hashtag prediction model 920, which is a prediction model of the MLM method. As another example, the first learning unit 770 may perform learning on the language model based on synopsis information, as illustrated in FIG. 9B. That is, the first learning unit 770 may perform learning on the language model based on synopsis information using a synopsis prediction model 960, which is a prediction model of the MLM method.

The second learning unit 780 performs secondary learning for the language model by using a prediction model that is configured to predict or infer a masked token. That is, the second learning unit 780 performs secondary learning, that is, additional learning for a language model that is primarily trained by the first learning unit 770. The second learning unit 780 may perform secondary learning for the language model by performing additional training on the primarily-trained language model through an MLM-type prediction model, based on other types of information in sequence-type text data of a content item obtained from the preprocessing unit 760, which were not used in the primary learning. According to one embodiment, when the primary learning is performed based on hashtag information, the secondary learning may be performed based on synopsis information in the sequence-type text data of the content item. For example, as illustrated in FIG. 9B, the second learning unit 780 may perform secondary learning on the language model based on synopsis information using the synopsis prediction model 960, which is a prediction model of the MLM method. According to one embodiment, when the primary learning is performed based on synopsis information, the secondary learning may be performed based on hashtag information in the sequence-type text data of the content item. For example, as illustrated in FIG. 9A, the second learning unit 780 may perform secondary learning on the language model based on hashtag information using the hashtag prediction model 920, which is a prediction model of the MLM method.

According to one embodiment, the second learning unit 780 may perform secondary learning using text metadata of content items used for learning of the first learning unit 770. According to one embodiment, the second learning unit 780 may select at least some content items having a type of information to be used for secondary learning among the content items used for learning of the first learning unit 770, and perform secondary learning using text metadata of at least some of the selected content items. For example, when hashtag information is used for secondary learning of the language model, the second learning unit 780 may select only content items having hashtag information among the content items used for learning of the first learning unit 770, and perform secondary learning using text metadata of the selected content items as a training data set for a prediction model. As another example, when synopsis information is used for the secondary learning of the language model, the second learning unit 780 may select only content items having synopsis information among the content items used for learning by the first learning unit 770, and perform secondary learning by using the text metadata of the selected content items as a training data set for the prediction model. However, this is only an example, and the training data set used for learning by the second learning unit 780 is not limited thereto.

In the description referring to FIG. 7B, the model learning unit 620 performs the primary learning based on hashtags using the prediction model of the MLM method and then performs the secondary learning based on synopsis, or performs the primary learning based on synopsis and then performs the secondary learning based on hashtags. However, the present disclosure is not limited thereto. That is, the model learning unit 620 may perform N-th learning using at least two types of information among various types of information included in the sequence-type text data of the obtained content item. For example, the model learning unit 620 may perform the primary learning based on synopsis or the primary learning based on hashtags using the prediction model of the MLM method and then perform the secondary learning based on genre using the prediction model of the text classification method. As another example, the model learning unit 620 may perform the primary learning based on genre using the prediction model of the text classification method, and then perform the secondary learning based on hashtags or the secondary learning based on synopsis using the prediction model of the MLM method. As another example, the model learning unit 620 may perform the primary learning based on synopsis using the prediction model of the MLM method, perform the secondary learning based on hashtags using the prediction model of the MLM method, and then perform tertiary learning based on genre using the prediction model of the text classification method.

In the above description, the model learning unit 620 performs learning on the language model by training the prediction model of the MLM method based on hashtag information or synopsis information, or performs learning on the language model by training the prediction model of the text classification method based on genre information. However, the present disclosure is not limited thereto. According to one embodiment, the model learning unit 620 may perform learning on the language model by training the prediction model of the MLM method based on different types of information other than hashtag information and synopsis information, or by training the prediction model of the text classification method based on different types of information other than genre information. For example, the model learning unit 620 may perform learning on the language model by using other information that may reflect the user's content preference. [Table 5] below is an example of an expression for the user's preferred content.

TABLE 5

| Example of favorite movie | |
|---|---|
| expressions | Criterion classification |
| I like action movies. | Genre (action) |
| I like Japanese movies. | Hashtag (# Japanese |
| | background) |
| I like movies directed by | Director |
| director Hong Gil-dong. | (Hong Gil-dong) |
| I want to see a touching movie. | Hashtag (# touching) |
| I trust and watch actor Kim | Actor (Kim Gil-dong) |
| Gil-dong's movies. | |

Table 5 shows that a user's preferred content can be reflected in the genre, hashtag, director or actor information of the content. As shown in Table 5, direct or actor information is information reflecting a user's content preference. However, since there are many pieces of target information corresponding to the director or actor information, and it is rare for the contents to have the same director information or the same actor information, it is difficult to learn a generalized semantic representation for the director or actor information. On the other hand, the hashtag or genre information reflects the user's content preference, but compared to other features (e.g., director, actor), the target information is relatively small, and the contents often have the same genre and/or hashtag. In addition, the genre information appears in each individual data within a given category, and the main nouns corresponding to the hashtag information are trained a lot in the pre-training stage. Therefore, it can be said that it is easy to learn a generalized semantic representation for the genre or hashtag information. That is, the model learning unit 620 may perform learning for a language model by performing training on an MLM-type prediction model through genre information. Alternatively, the model learning unit 620 may perform learning for a language model by performing training on a text classification-type prediction model based on hashtag information. Alternatively, the model learning unit 620 may perform learning for a language model by using any one type of information among various types of information in text metadata of content.

The search term acquisition unit 630 obtains a search term for content search from the client device 110. For example, the search term acquisition unit 630 may obtain a text-type search term through wired/wireless communication with the client device 110. According to one embodiment, the search term acquisition unit 630 may obtain a search term in the form of voice data from the client device 110. In this case, the search term acquisition unit 630 may convert voice data to text data.

The similarity determination unit 640 determines similarity between a search term and a content item by using a language model that is trained in the model learning unit 620. To this end, the similarity determination unit 640 may obtain the search term from the search term acquisition unit 630 and determine a vector of the search term by using the trained language model. Herein, the search term may be composed of natural language, that is, unstructured data. For example, the search term may be natural language in the form of a word, word segment, or sentence that includes at least one keyword. The similarity determination unit 640 may convert the search term to fit a specified input format and input the converted search term into a language model. For example, the similarity determination unit 640 may convert a search term to input 1, input 2, input 3, or input 4, as shown in Table 6 below.

TABLE 6
Input 1: [CLS]search term divided into token units[SEP]
Input 2: [CLS]search term divided into token units [SEP] search term
divided into token units [GENRE][MASK][/GENRE][SEP]
Input 3: [CLS]search term divided into tokens [SEP] search term divided
into tokens [TAG][MASK][/TAG][SEP]
Input 4: [CLS] search term divided into token units [SEP] [MASK] [SEP]

In Table 6, [CLS] and [SEP] are special tokens that are inserted to indicate the start and end positions of a corresponding search term, respectively, and are commonly included in input 1, input 2, input 3, and input 4. Herein, [CLS] and [SEP] are inserted at the start and end positions, respectively, to follow an input format universally used in training of language models, that is, a standard input format. Specifically, input 1 may be a standard input format that includes [CLS] at the start position and [SEP] at the end position. In addition, input 2 and/or input 3 may be a standard input format that is intended to follow an input format of Table 2, Table 3, or Table 4 that is used to train a language model according to one embodiment of the present disclosure. Herein, in input 2 and/or input 3, [SEP] is inserted between search terms to enable training of a language model through [SEP] between a title and synopsis in Table 2, Table 3, or Table 4 to be reflected in a process of determining a vector of a search term. In addition, the form <attribute1>[SEP]<attribute2>[GENRE][MASK][/GENRE] of input 2 is intended to enable prediction of [MASK] from a genre perspective, using <attribute1> and <attribute2> when determining a vector of a search term. Especially, addition of [GENRE][MASK][/GENRE] to predict a masked token from the genre perspective is intended to apply a weight to a position of a genre special token. That is, as input 2 includes [GENRE][MASK][/GENRE], a language model may infer a masked genre token based on search term corresponding to <attribute1> and <attribute2> of input 2 and output a vector of a search term by using vector values of a last hidden layer. Herein, a weight may be applied to a position of the inferred genre token, but the present disclosure is not limited thereto. In addition, the form <attribute1>[SEP]<attribute2>[TAG][MASK][/TAG] of input 3 is intended to enable prediction of [MASK] from a hashtag perspective, using <attribute1> and <attribute2> when determining a vector of a search term. Especially, addition of [TAG][MASK][/TAG] is intended to follow an input format used for training of a language model, thereby enabling pre-trained information of the language model to be reflected in the [MASK] position. Input 4 is a form in which synopsis located after [SEP] is masked according to the <title>[SEP]<synopsis> format of Table 3. By configuring Input4 to have the form <attribute1>[SEP][MASK], it is possible to enable prediction of [MASK] from a synopsis perspective by using <attribute1> when determining a vector of a search term.

The similarity determination unit 640 may convert the search term to fit a specified input format and input the converted search term into a trained language model. For example, when the search term is “a thrilling movie,” the similarity determination unit 640 may convert the search term into [CLS]/a/thrilling/movie/[SEP], as in input 1, into [CLS]/a/thrilling/movie/[SEP]/a/thrilling/movie/[GENRE][MASK][/GENRE][SEP], as in input 2, into [CLS]/a/thrilling/movie/[SEP]/a/thrilling/movie/[TAG][MASK][/TAG][SEP], as in input 3, or into [CLS]/a/thrilling/movie/[SEP][MASK][SEP], as in input 4.

The similarity determination unit 640 may obtain a vector of a search term by inputting a converted search term into a trained language model. The above-described input 1, input 2, input 3 and input 4 of Table 6 are merely examples of specified input formats for search term, and the present disclosure is not limited thereto. That is, the specified input format of a search term may be variously configured by a designer. For example, the specified input format of a search term may be configured as “[CLS] search term divided into token units [GENRE] [MASK] [/GENRE][SEP]” or “[CLS] search term divided into token units [TAG][MASK][/TAG][SEP]”. That is, the specified input format for a search term may have an input structure that enables a trained language model to predict a mask through tokens corresponding to the search term, even if the search term is included only once and not repeated according to <title>[SEP]<synopsis> of Table 2. As another example, the specified input format for a search term may be configured as “[CLS] search term divided into token units [SEP] search term divided into token units [SEP]”.

According to one embodiment, a specified input format may be configured based on a learning method of a language model. For example, when the model learning unit 620 performs training of a language model based on a hashtag prediction model 920 illustrated in FIG. 9A, a specified input format for a search term may be configured as input 1 or input 3. As another example, when the model learning unit 620 performs training of a language model based on a synopsis prediction model 960 illustrated in FIG. 9B, a specified input format for a search term may be configured as input 1 or input 4. As still another example, when the model learning unit 620 performs training of a language model based on a genre prediction model 1020 illustrated in FIG. 10A, a specified input format for a search term may be configured as input 1. This is merely one example, and the present disclosure is not limited thereto. For example, a specified input format for a search term may be configured irrespective of the learning method of a language model.

According to one embodiment, even when a language model does not perform learning based on a masked language model (MLM), a specified input format for a search term to be input into the trained language model may include a masked token. This is because the language model can contextually understand the role of a masked token. That is, because an MLM task for language data is basically performed when a language model is constructed through learning of a language system, even if the language model is trained through genre prediction, it may infer [MASK] included in inputs.

The similarity determination unit 640 may obtain a vector of each of at least one content item through a trained language model, either periodically or when a specified event occurs. That is, the similarity determination unit 640 may obtain text metadata for each content item stored in the content storage unit 610 and convert the obtained text metadata into sequence-type text data. The similarity determination unit 640 may obtain a vector of each content item based on sequence-type text data obtained according to each content item by using a trained language model and store the obtained vector of each content item in a content vector DB 612. According to one embodiment, when a language model is trained based on a genre prediction model using a text classification method, the similarity determination unit 640 may generate input sequence-type text data for each content item by removing genre-related tokens from sequence-type text data of each content item, so that the input sequence-type text data for each content item does not include any genre-related tokens. The similarity determination unit 640 may obtain a vector of each content item based on input sequence-type text data that is obtained for each content item by using a trained language model. A specified event may include an event in which a new content item is additionally stored in the content storage unit 610, and/or an event in which an operator and/or administrator requests to obtain a vector for each content item.

The similarity determination unit 640 determines similarity between a search term and a content item, based on a vector of the search term and a vector of each content item. Herein, a vector of a content item stored in the content storage unit 610 may be obtained from the content vector DB 612 or obtained in real time using a trained language model.

For example, the similarity determination unit 640 may determine similarity, as illustrated in FIG. 11. FIG. 11 illustrates an example of calculating similarity between a search term and content by using a trained language model according to an embodiment of the present disclosure. Referring to FIG. 11, the similarity determination unit 640 may obtain a vector 1104a of semantic search term 1 from a search term 1102a in a specified input format of semantic search term 1 by using a RoBERTa model 1120-1 and obtain a vector 1104b of content 1 from <content1 Data> 1102b, which is sequence-type text data or input sequence-type text data of content 1, by using a RoBERTa model 1120-2. Herein, the two RoBERTa models 1120-1 and 1120-2 are described to be used, but this is intended to emphasize that a single vector is obtained for each of semantic search term 1 and content 1, and the similarity determination unit 640 may repeatedly use one RoBERTa model or perform parallel processing. That is, the two RoBERTa models 1120-1 and 1120-2 may be identical models that are trained in a same manner.

The similarity determination unit 640 may calculate similarity between the vector 1104a of semantic search term 1 and the vector 1104b of content 1 by using a similarity calculation block 1140 that calculates similarity between vectors. For example, the similarity calculation block 1140 may calculate similarity based on a cosine similarity algorithm. The similarity between the vector 1104a of semantic search term 1 and the vector 1104b of content 1 may be interpreted as similarity 1106 between a search term and content 1.

According to one embodiment, the similarity determination unit 640 may exclude a head layer (e.g., MLM head layer or text classification head layer), which is used to train a language model in the model learning unit 620, and determine a vector value for sequence-type text data of corresponding content by using embedding values of a last hidden layer of the language model. In other words, a model used for determining similarity and a model used for fine-tuning may have different architectures. That is, in a training stage for fine-tuning, a model may include an MLM head layer for predicting a masked token, or a text classification head layer for inferring a genre, but in a stage for determining similarity, a model may not include a head layer, and may further include a similarity calculation block.

According to various embodiments, the similarity determination unit 640 may obtain a vector of a search term and a vector of a content item, that is, input text vectors to be used for calculating similarity. Embodiments for determining input text vectors will be described as follows.

According to one embodiment, a method using a pooler output may be applied. Specifically, when using a pooler output, the last hidden layer output vector of the [CLS] token of the language model is used as an input text vector.

According to one embodiment, a method using the average of the last hidden states values may be applied. When using the average of the last hidden states values, a vector obtained through average pooling for the last hidden layer output vector of all words of the language model is used as the input text vector.

According to one embodiment, a method using the maximum value of the last hidden state values may be applied. When using the maximum value of the last hidden state values, a vector obtained through max pooling for the last hidden layer output vector of all words of the language model is used as an input text vector.

Among the various embodiments described above, the similarity determination unit 640 may obtain an input text vector for similarity calculation according to a method using the average of the last hidden state values.

Additionally, the similarity determination unit 640 may assign weights to the positions of specific features among the last hidden state values of the language model. Examples of assigning weights are as follows. In the following description, as an example to help understanding, it is assumed that a weight of 2 (e.g., 2 times) is applied, but the weight is not limited to 2. For example, the weight may be k, and k may be a real number greater than 1.

According to one embodiment, a method of assigning weights to hashtag values may be applied. In this case, vector values corresponding to tokens located between [TAG] and [/TAG], which are special tokens indicating the hashtag area among vector values of the last hidden layer, may be assigned a weight of double.

According to one embodiment, a method of assigning weights to genre values may be applied. In this case, a weight of double may be assigned to vector values corresponding to tokens located between [GENRE] and [/GENRE], which are special tokens indicating a genre area among vector values of the last hidden layer. For example, after average pooling for vector values corresponding to tokens, an average may be calculated again only for vectors located at the genre position, and then the average may be added to the average pooling result. However, embodiments of the present disclosure are not limited thereto. For example, during average pooling, a weight may be applied to each feature position, and a weighted average may be calculated.

According to one embodiment, a method of assigning a weight to title and synopsis values may be applied. In this case, among vector values of a last hidden layer, a double weight may be assigned to vectors values corresponding to tokens located before and after [SEP].

According to one embodiment, a method of assigning a weight to genre and hashtag values may be applied. In this case, among vector values of a last hidden layer, a double weight may be assigned to vectors values corresponding to tokens located between [TAG] and [/TAG] and tokens located between [GENRE] and [/GENRE].

According to one embodiment, a method of assigning a weight to values of different types of features (e.g., title and hashtag values or synopsis and hashtag values) may be applied. In this case, among vector values of a last hidden layer, a double weight may be assigned to vectors values corresponding to any one token among tokens located between [TAG] and [/TAG], tokens located before [SEP], and tokens located after [SEP].

According to one embodiment, when training of a language model is performed based on hashtag information, a method of assigning a weight to genre values may be applied. In this case, among vector values of a last hidden layer, a double weight may be assigned to vectors values corresponding to tokens located between [GENRE] and [/GENRE] that are special tokens indicating a genre area.

In the above-described various embodiments, the similarity determination unit 640 may assign a weight to vector values corresponding to a location of at least one feature among vector values of a last hidden layer. After assigning the weight, the similarity determination unit 640 may determine an average of vectors values of the last hidden layer, thereby obtaining an input text vector for calculating similarity. For example, after average pooling on vector values corresponding to tokens, an average may be calculated only for vectors at the location of a specific feature to which a weight is assigned, and the average may then be added to the average pooling result. However, the embodiments of the present disclosure are not limited thereto. For example, a weight may be applied to the location of each feature in average pooling, and a weighted average may be computed.

According to one embodiment, if the language model is trained based on a genre prediction model, which is a text classification prediction model, genre values may not exist in the vector values of the last hidden layer. This is because there are no genre-related tokens in the input sequence-type text data input to the language model. In this case, among the weighting methods described above, the method of assigning weights to genre values will not be applied.

The content determination unit 650 may determine content items similar to a search term based on similarity between the search term and content items as determined by the similarity determination unit 640, and may generate a content search list including the determined content items. The content determination unit 650 may check similarity of each content item with respect to a search term and may generate a content search list based on the similarity. For example, the content determination unit 650 may select a specified number of content items in descending order of similarity with a search term among content items stored in the server 120 and generate a content search list including the selected content items. That is, content items included in a content search list may be arranged according to similarity.

In the foregoing description, the model learning unit 620 may add frequent words of text metadata of content items to a base language model's vocabulary and perform training using the vocabulary to which the frequent words have been added. When a frequent word is added to a vocabulary, the frequent word may not be segmented but recognized as a single token in a language model. For example, frequent words representing major genres may be added to a vocabulary. When frequent words representing a major genre are added to a vocabulary, the frequent words representing the major genre are recognized as single tokens in a language model, and thus a sequence length recognizable to the language model increases so that higher performance may appear.

In the above-described embodiments, the model learning unit 620 is described as being included in the server 120. That is, the server 120, which uses a trained language model, may perform training for a language model. However, according to another embodiment, training for a language model may be performed by an entity different from the server 20. In this case, the model learning unit 620 may not be included in the server 20, and the server 20 may receive information on a trained language model from a third device, construct the trained language model, and then determine similarity between a search term and a content item.

In the foregoing description, the client device 110 provides a search term to the server 120. Accordingly, it is not easy for the server 120 to predict in advance what search term will be entered from the client device 110. Therefore, when the client device 110 requests the server 120 to search for content corresponding to a specific search term, the server 120 should compute a vector for the search term in real time. However, since content items are stored beforehand in the server 120, vectors for the items may be obtained regardless of when a content search is requested. That is, whenever additional new content items are stored in the server 120, the server 120 may calculate vector values for the new content items by using a pre-trained language model and store the calculated vector values for respective content items in the content vector DB 612. When content search is requested, the server 120 may use a vector value of each content item stored in the content vector DB 612, thereby reducing time required for generating a content search item.

According to one embodiment, the vector values for each content item may be stored at a location at which a trained language model is saved. Thus, when the server 120 determines similarity between a search term for content search and content, the server 120 may use vector values of respective content items at a same location or in a same path.

In the foregoing description, to obtain a vector value of a content item, input sequence-type text data with genre-related tokens removed was used as input to a language model trained by a genre prediction model, which is a text classification-based prediction model. However, the embodiments of the present disclosure are not limited thereto. For example, a server according to one embodiment of the present disclosure or the similarity determination unit 640 may use sequence-type text data including genre-related tokens as input to a trained language model, even when the trained language model is trained by a genre prediction model that is a text classification-based prediction model. For example, the server or the similarity determination unit 640 may obtain a vector value of each content item by inputting sequence-type text data including genre-related tokens, as shown in Table 1, to the trained language model.

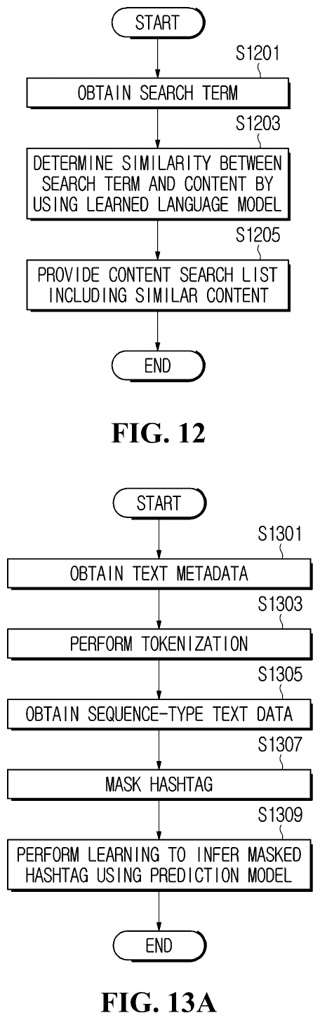

FIG. 12 illustrates an example of a procedure of searching for content by using a trained language model according to one embodiment of the present disclosure. The agent of FIG. 12 may be the server 120 of FIG. 1.

Referring to FIG. 12, in step S1201, the server obtains a search term. The server may obtain a search term in the form of text data from a client device. According to one embodiment, the server may receive a content search request message including the search term from the client device and extract the search term from the content search request message. The search term may include unstructured text data that is natural language. For example, the server may obtain a search term composed of unstructured text data, such as “thrilling movie”.

In step S1203, the server determines similarity between the search term and a content item by using the trained language model. The server may obtain a vector value of the search term and a vector value of each content item by using the language model trained based on metadata of contents, that is, text metadata. Herein, the vector value of each content item may be obtained in real time using the language model trained based on the metadata of contents, or may be obtained and stored in advance using the language model trained based on the metadata of contents before the search term is obtained. The language model trained based on the metadata of contents may include a language model trained by the model learning unit 620. The server may determine similarity between the search term and the content items based on the vector of the search term and the vector value of each content item. For example, the server may obtain a vector of a search term by inputting the search term converted into any one input format of the input formats of Table 6 to a trained language model and may obtain a vector of a first content by inputting sequence-type text data of a first content item to the trained language model. The server may calculate similarity between the two vectors by using a similarity algorithm (e.g., cosine similarity algorithm). The server may determine the calculated similarity as similarity between the search term and the first content item. Thus, the server may calculate similarity between the search term and each of the content items.

In step S1205, the server may provide a content search list including at least one content item that is similar to the search term. That is, the server may determine at least one content item similar to the search term, based on similarity between the search term and contents, and may generate a content search list including information on the at least one determined content item. For example, the server may select, among content items held by it, a predetermined number of content items in descending of similarity or content items with a similarity equal to or greater than a threshold value. For example, the server may select, among candidate content items specified according to a different criterion, a predetermined number of content items in descending of similarity or content items with a similarity equal to or greater than a threshold value. In addition, the server may generate a content search list including information on the selected content items and provide the generated content search list to the client device. In other words, the server may transmit the content search list to the client device. Herein, a specific form of the content search list may be different according to an environment, a service, and the like, in which a content search result is provided.

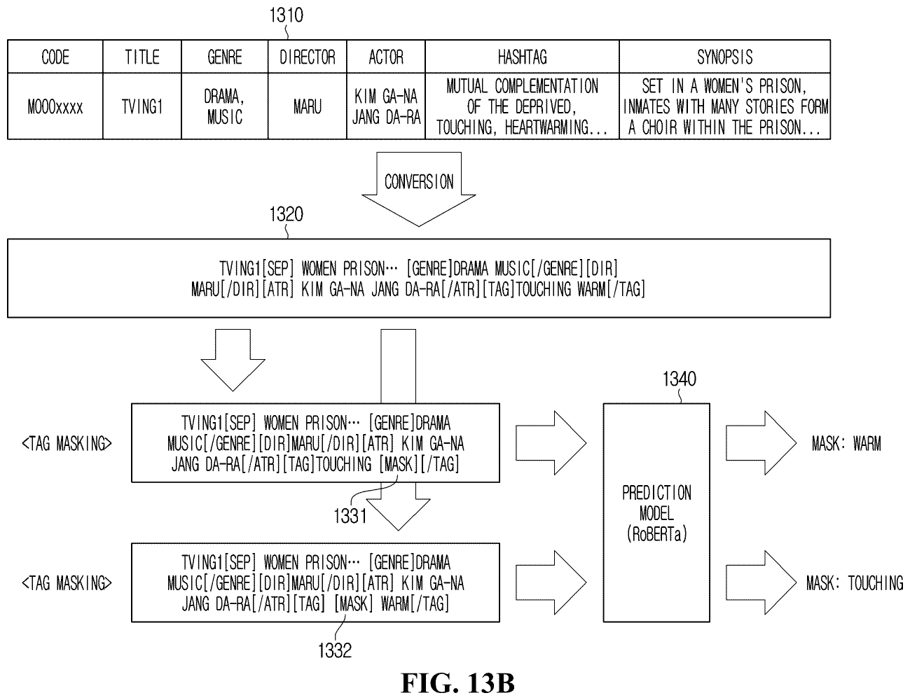

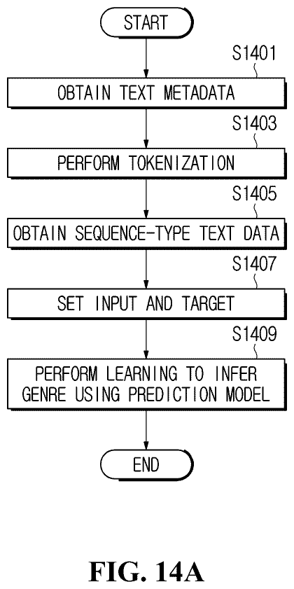

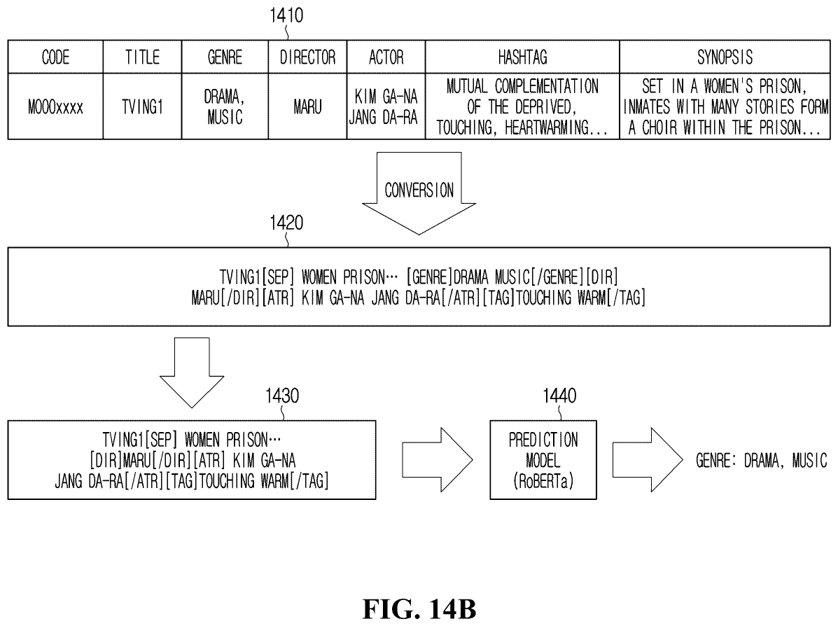

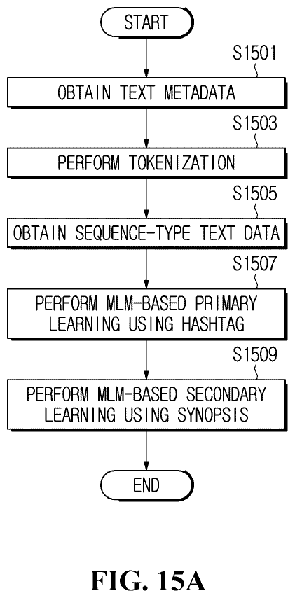

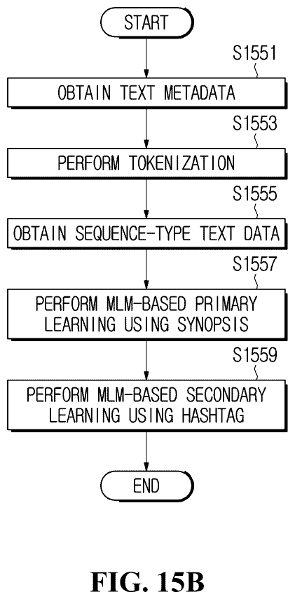

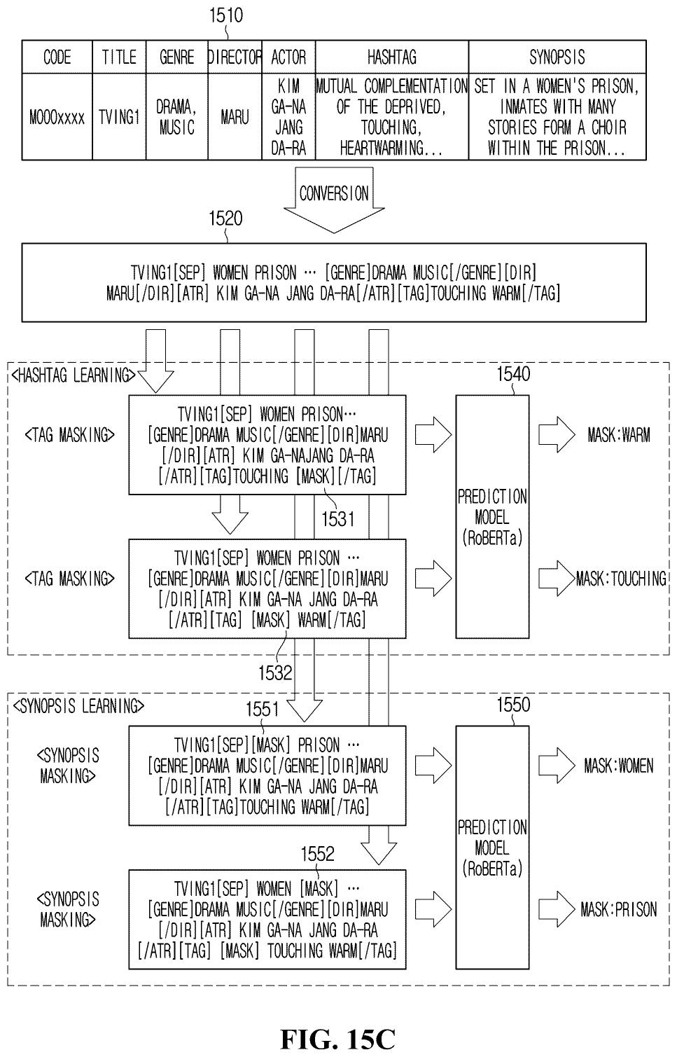

In the description referring to FIG. 12, the trained language model may be a language model trained by any one procedure of FIG. 13A, FIG. 14A, FIG. 15A, or FIG. 15B.

FIG. 13A illustrates an example of a procedure of performing learning for a language model according to an embodiment of the present disclosure. Hereinafter, at least some operations of FIG. 13A may be performed sequentially or performed in parallel. For example, some operations of FIG. 13A may be performed at least temporarily at the same time. Hereinafter, at least some operations of FIG. 13A will be described with reference to FIG. 13B. FIG. 13B illustrates an example of learning of a language model using a language model according to one embodiment of the present disclosure.

Referring to FIG. 13A, in step S1301, a server obtains text metadata for content. For example, as illustrated in FIG. 13B, the server may obtain text metadata 1310 including the title, genre, director, actor, hashtag and synopsis of the content.

In step S1303, the server performs tokenization on the text metadata. For example, the server may divide the text metadata into token units by using a byte pair encoding (BPE) algorithm or a morphological analyzer. The BPE algorithm is an information compression algorithm that merges most frequently occurring strings in target data to compress the data, and may be composed of a vocabulary construction stage and a tokenization stage. Specifically, the BPE algorithm is an algorithm that merges strings, which frequently occur in data, builds a vocabulary set by adding the merged strings to the vocabulary set, and then separates a sub-word of the vocabulary set from each word segment in target data when the sub-word is included in the word segment. The morphological analyzer is a technique that segments the target data into morphemes, which are the smallest semantic units.

In step S1305, the server obtains sequence-type text data. For example, the sequence-type text data may be obtained by adding at least one separator to data separated into token units. For example, the sequence-type text data may be determined as in FIG. 13B. Referring FIG. 13B, the server may obtain sequence-type text data 1320 by separating text metadata 1310 of contents into tokens and inserting at least one separator token and at least a special token (e.g., a genre token, a director token, an actor token, a hashtag token, etc.) into the tokens.

In step S1307, the server masks the hashtag. The server may mask any one of a plurality of tokens located in the hashtag area. At this time, the hashtag area may be identified based on special tokens [TAG] and [/TAG] representing the hashtag. For example, referring to FIG. 13B, the server may recognize that a “touching” token and a “warm” token exist between [TAG] and [/TAG] in the sequence-type text data 1320, and may replace the “warm” token with [MASK] 1331 or replace the “touching” token with [MASK] 1332. According to one embodiment, the server may mask a token that does not start with “#” among the plurality of tokens located in the hashtag area. Masking tokens that do not start with “#” is because tokens that include core meaning, such as nouns and verbs, do not start with “#”.

In step S1309, the server performs learning to infer the masked hashtag using a language model-based prediction model. For example, as illustrated in FIG. 13B, if the “warm” token is masked, the server may be trained to infer the masked hashtag “warm” using the prediction model 1340, and if the “emotion” token is masked, the server may be trained to infer the masked hashtag “emotion” using the prediction model 1340. At this time, the prediction model 1340 may be trained by backpropagating a loss value to infer the masked hashtag. Through this, the parameters of the language model that derives the vector of each token in the prediction model 1340 may be updated so that the vectors of the tokens of the title and synopsis may reflect the semantic information of the masked hashtag.

The server may repeatedly perform steps S1301, S1303, S1305, S1307 and S1309 described above for the plurality of content items. In addition, the server may repeatedly perform steps S1307 and S1309 for the plurality of tokens within the hashtag area. In this way, when the random masking training method for the plurality of hashtag information is repeated, the parameters of the language model may be updated so that the semantic information of the plurality of hashtags is reflected in the vectors of other tokens within the sequence-type text data. Accordingly, the language model may be trained to provide a more sophisticated semantic representation by a task of inferring masked tokens as illustrated in FIG. 13B, thereby better identifying similarities between contents.

In addition, as described above, the trained language model may return a vector including information about hashtag features from other types of features (e.g., title, synopsis) in the sequence-type text data, even when there is a lack of or no hashtags in the sequence-type text data.

FIG. 14A illustrates an example of a procedure of performing learning for a language model according to one embodiment of the present disclosure. Hereinafter, at least some operations of FIG. 14A may be performed sequentially or performed in parallel. For example, some operations of FIG. 14A may be performed at least temporarily at the same time. Hereinafter, at least some operations of FIG. 14A will be described with reference to FIG. 14B. FIG. 14B illustrates an example of learning of a language model using genre prediction according to one embodiment of the present disclosure.

Referring to FIG. 14A, in step S1401, a server obtains text metadata for content. For example, as illustrated in FIG. 14B, the server may obtain text metadata 1410 including the title, genre, director, actor, hashtag and synopsis of the content.

In step S1403, the server performs tokenization on the text metadata. Tokenizing on the text metadata may be performed in the same manner as described in step S1303 of FIG. 13.

In step S1405, the server obtains sequence-type text data. For example, the sequence-type text data may be obtained by adding at least one separator to data separated into token units. For example, the sequence-type text data may be determined as in FIG. 14B. For example, referring FIG. 14B, the server may obtain sequence-type text data 1420 by separating metadata 1410 into tokens and inserting at least one separator token and at least a special token (e.g., a genre token, a director token, an actor token, a hashtag token, etc.) into the tokens.

In step S1407, the server sets the input and target of the prediction model. The server may obtain input sequence-type text data by removing genre-related tokens from the sequence-type text data, and set a target label based on the genre-related token. For example, referring to FIG. 14B, the server may recognize that a “drama” token and a “music” token exist between [GENRE] and [/GENRE] in the sequence-type text data 1420, and set the input sequence-type text data 1430 from which these are removed as the input of the prediction model. In addition, the server may set a target label based on the “drama” token and the “music” token located between [GENRE] and [/GENRE] in the sequence-type text data 1420.

In step S1409, the server performs learning to infer a genre for input sequence-type text data using a language model-based prediction model. For example, as illustrated in FIG. 14B, the server may perform learning for the prediction model 1440 so that the genre for the input sequence-type text data 1430 is inferred as “drama” and “music.” At this time, the prediction model 1440 may be trained by backpropagating a loss value to infer a genre set as a target. Through this, parameters of the language model that derives the vector of each token in the prediction model 1440 may be updated so that the vectors of the tokens of the title, synopsis, and hashtag may reflect the semantic information of the genre token.

As described above, the trained language model may return a vector including information about genre features from other types of features (e.g., title, synopsis) in the sequence-type text data, even if there is no genre information in the sequence-type text data.

FIG. 15A illustrates an example of a procedure of performing learning for a language model according to one embodiment of the present disclosure. Hereinafter, at least some operations of FIG. 15A may be performed sequentially or performed in parallel. For example, some operations of FIG. 15A may be performed at least temporarily at the same time. Hereinafter, at least some operations of FIG. 15A will be described with reference to FIG. 15C. FIG. 15C illustrates an example of learning of a language model using hashtag and synopsis according to one embodiment of the present disclosure.

Referring to FIG. 15A, in step S1501, the server obtains text metadata for content. For example, as illustrated in FIG. 15C, the server may obtain text metadata 1510 including the title, genre, director, actor, hashtag and synopsis of the content.

In step S1503, the server performs tokenization on the text metadata. Tokenizing on the text metadata may be performed in the same manner as described in step S1303 of FIG. 13.

In step S1505, the server obtains sequence-type text data. For example, the sequence-type text data may be obtained by adding at least one separator to data separated into token units. For example, the sequence-type text data may be determined as in FIG. 15C. Referring FIG. 15C, the server may obtain sequence-type text data 1520 by separating metadata 1510 into tokens and inserting at least one separator token and at least a special token (e.g., a genre token, a director token, an actor token, a hashtag token, etc.) into the tokens.

In step S1507, the server performs MLM-based primary learning using hashtags. The server masks any one hashtag token among a plurality of hashtag tokens located in the hashtag area of sequence-type text data, and performs primary learning to infer the masked hashtag token using a language model-based prediction model. At this time, the hashtag area may be identified based on [TAG] and [/TAG], which are special tokens representing hashtags. For example, referring to FIG. 15C, the server recognizes that a “touching” token and a “warm” token exist between [TAG] and [/TAG] in the sequence-type text data 1520, and replaces the “warm” token with [MASK] 1531 or replaces the “touching” token with [MASK] 1532. According to one embodiment, the server may mask tokens that are not dependent tokens among the plurality of tokens located in the hashtag area. As illustrated in FIG. 15C, when the “warm” token is masked, the server may perform learning on the prediction model 1540 to infer the masked hashtag token “warm,” and when the “touching” token is masked, the server may perform learning on the prediction model 1540 to infer the masked hashtag token “touching.” At this time, the prediction model 1540 may be trained by backpropagating a loss value to infer the masked hashtag token. Through this, the parameters of the language model that derives the vector of each token in the prediction model 1540 may be updated so that the vectors of the tokens of the title and the synopsis may reflect the semantic information of the masked hashtag. The server may obtain a primarily trained language model by repeating the hashtag masking and inference operations described above multiple times for a plurality of content items.

In step S1509, the server performs MLM-based secondary learning using synopsis. The server masks any one synopsis token among a plurality of synopsis tokens located in the synopsis area of the sequence-type text data, and performs secondary learning to infer the masked synopsis token using a language model-based prediction model. At this time, the synopsis area may be identified based on a separator token [SEP] and a special token [GENRE] for the genre area. For example, referring to FIG. 15C, the server recognizes that a “woman” token and a “prison” token exist between [SEP] and [GENRE] in the sequence-type text data 1520, and replaces the “woman” token with [MASK] 1551 or replaces the “prison” token with [MASK] 1552. According to one embodiment, the server may mask a token that is not a dependent token among a plurality of tokens located in the synopsis area. As illustrated in FIG. 15C, the server may perform learning on the prediction model 1550 to infer the masked synopsis token “woman” when the “woman” token is masked, and may perform learning on the prediction model 1550 to infer the masked synopsis token “prison” when the “prison” token is masked. At this time, the prediction model 1550 may include a language model primarily trained in step S1507, that is, a language model trained based on a hashtag. The prediction model 1550 may be trained by backpropagating a loss value to infer the masked synopsis token. Through this, the parameters of the language model that derives the vector of each token in the prediction model 1540 may be updated so that the vectors of the tokens of the title, hashtag, or genre may reflect the semantic information of the masked synopsis token. The server may obtain a secondarily trained language model by repeating the synopsis masking and inference operations described above multiple times for a plurality of content items.

FIG. 15B illustrates an example of a procedure for performing learning on a language model according to an embodiment of the present disclosure. At least some of the operations of FIG. 15B below may be performed sequentially or in parallel. For example, some of the operations of FIG. 15B may be performed at least temporarily at the same time. At least some of the operations of FIG. 15B below will be described with reference to FIG. 15C.

Referring to FIG. 15B, in step S1551, the server obtains text metadata for the content. For example, as illustrated in FIG. 15C, the server may obtain text metadata 1510 including the title, genre, director, actor, hashtag, and synopsis of the content.

In step S1553, the server performs tokenization on the text metadata. Tokenizing on the text metadata may be performed in the same manner as described in step S1303 of FIG. 13A.

In step S1555, the server obtains sequence-type text data. For example, the sequence-type text data may be obtained by adding at least one separator to data separated into token units.

In step S1557, the server performs MLM-based primary learning using synopsis. The server masks any one synopsis token among a plurality of synopsis tokens located in the synopsis area of the sequence-type text data and performs primary learning to infer the masked synopsis token using a language model-based prediction model.

In step S1559, the server performs MLM-based secondary learning using hashtag. The server masks any one hashtag token among a plurality of hashtag tokens located in the hashtag area of the sequence-type text data and performs secondary learning to infer the masked hashtag token using a language model-based prediction model.

As shown in FIG. 15A and FIG. 15B described above, when the random masking training method for the plurality of hashtag tokens and the plurality of synopsis tokens is repeated, the parameters of the language model may be updated so that the semantic information of the plurality of hashtag tokens and the semantic information of the plurality of synopsis tokens are reflected in the vectors of other tokens in the sequence-type text data. Accordingly, the language model may be trained to provide more sophisticated semantic representations by the task of inferring masked tokens as illustrated in FIG. 15A and FIG. 15B, thereby better identifying similarities between contents.

In addition, as described with reference to FIGS. 15A and 15B, the trained language model may return a vector including information about a hashtag feature from other types of features (e.g., title, genre) in the sequence-type text data, even when there is a lack of or not hashtags or synopsis in the sequence-type text data.

FIG. 15A illustrates a procedure in which a server performs primary learning on a language model based on hashtag information using MLM, and then performs secondary learning on a language model based on synopsis, and FIG. 15B illustrates a procedure in which a server performs primary learning on a language model based on synopsis information using MLM, and then performs secondary learning on a language model based on hashtags. In general, hashtag information of content items includes information related to a user's content preference or information that may reflect the user's content preference, while synopsis information may include not only information related to the user's content preference but also information unrelated to the user's content preference. Therefore, the performance of the language model may vary depending on whether hashtag information or synopsis information is used first when training the language model. Specifically, as shown in FIG. 15A, when a language model is trained based on synopsis information after being trained with hashtag information, the parameters of the language model may quickly converge to values close to the optimal values based on the hashtag information, and then be fine-tuned more based on the synopsis information. On the other hand, as shown in FIG. 15B, when first performing learning with the synopsis information among the hashtag information and synopsis information, overfitting of the trained language model can be prevented. Overfitting refers to a state in which a language model is overly adapted to learning data, resulting in deterioration in performance for data other than the learning data. In other words, since synopsis information includes information unrelated to the user's content preference, the overfitting phenomenon of the language model can be suppressed.

In the description referring to FIG. 15A and FIG. 15B, the language model is trained based on hashtag information and synopsis information in the metadata of content items, but other information may be used to train the language model. For example, the language model may be primarily trained using hashtag information based on MLM, and then secondarily trained using genre information. As another example, the language model may be primarily trained using synopsis information based on MLM, and then secondarily trained using genre information.

Additionally, the language model may be trained using only synopsis information of content items based on MLM.

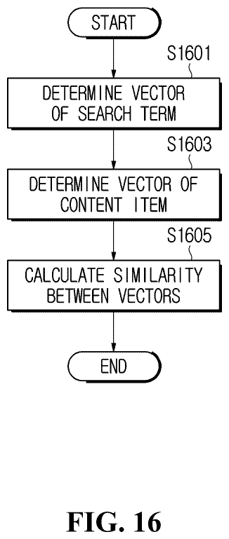

FIG. 16 illustrates an example of a procedure of determining similarity between a search term and content by using a trained language model according to one embodiment of the present disclosure. The operations of FIG. 16 are an example of operation S1203 of FIG. 12, and may be understood as a procedure for determining the similarity between a search term and one content item. Hereinafter, at least some operations of FIG. 16 may be performed sequentially or performed in parallel. For example, some operations of FIG. 16 may be performed at least temporarily at the same time.

Referring to FIG. 16, in step S1601, the server determines a vector of a search term. Here, the vector of the search term may be determined based on a language model that is trained in advance to infer a hashtag. For example, the server may obtain a search term, perform tokenization on the obtained search term, and then insert at least one separator, thereby obtaining a converted search term that observes any one of the input formats of Table 6. In addition, the server may obtain a vector corresponding to the converted search term by using the trained language model. Specifically, the server may determine the vector, that is, an embedding value by inputting the converted search term to the trained language model and obtaining output data of the language model. The trained language model may be a language model that is trained by the model learning unit 620, as described in FIG. 6. However, except for a head layer (e.g., MLM head layer or text classification head layer) used for learning in the language model for similarity calculation, a last hidden layer embedding value of the language model itself may be used as the embedding value for the text metadata of the content. At this time, according to one embodiment, the server may determine the vector of the search term for similarity calculation by using any one of a method of using a pooler output, a method of using an average of last hidden state values, or a method of using a maximum value of the last hidden state values. In addition, according to one embodiment, when determining the vector of the search term for similarity calculation, the server may give a weight to a value corresponding to the position of a specific feature among the last hidden state values.

In step S1603, the server determines a vector of the content item. Here, the vector may be determined based on sequence-type text data determined using text metadata. For example, the server may obtain text metadata of the content item, perform tokenization on the obtained text metadata, and then obtain sequence-type text data by inserting at least one separator. In addition, the server may obtain a vector corresponding to the sequence-type text data of the content item by using the trained language model. Specifically, the server may determine the vector, that is, an embedding value by inputting the sequence-type text data to the trained language model and obtaining output data of the language model. The trained language model may be a language model that is trained by the model learning unit 620, as described in FIG. 6. However, except for a head layer (e.g., MLM head layer or text classification head layer) used for learning in the language model for similarity calculation, a last hidden layer embedding value of the language model itself may be used as the embedding value for the text metadata of the content. At this time, according to one embodiment, the server may determine the vector of the content for similarity calculation by using any one of a method of using a pooler output, a method of using an average of last hidden state values, or a method of using a maximum value of the last hidden state values. In addition, according to one embodiment, when determining the vector of the content for similarity calculation, the server may give a weight to a value corresponding to the position of a specific feature among the last hidden state values.

In step S1605, the server determines similarity between the search term and the content item. That is, the server may determine the similarity between the search term and the content item based on a cosine similarity algorithm. For example, the server may calculate similarity between the vector of the search term and the vector of the content item and may determine the calculated similarity as the similarity between the search term and the content item.

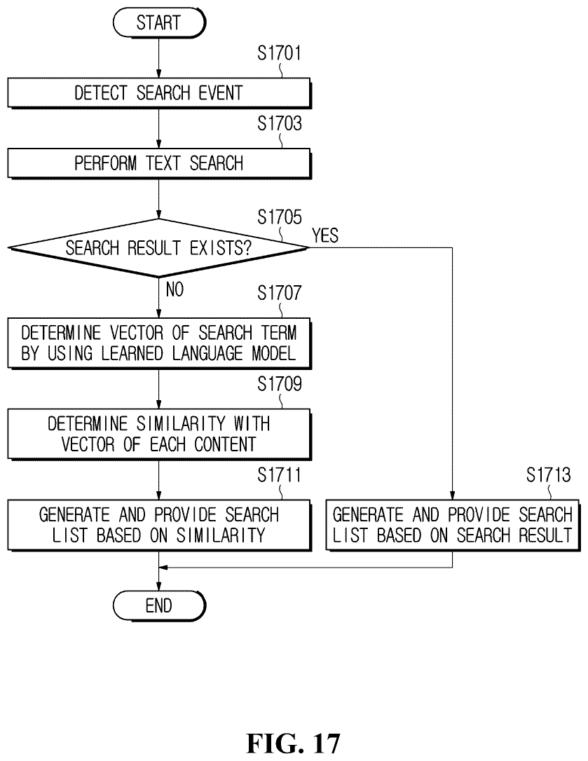

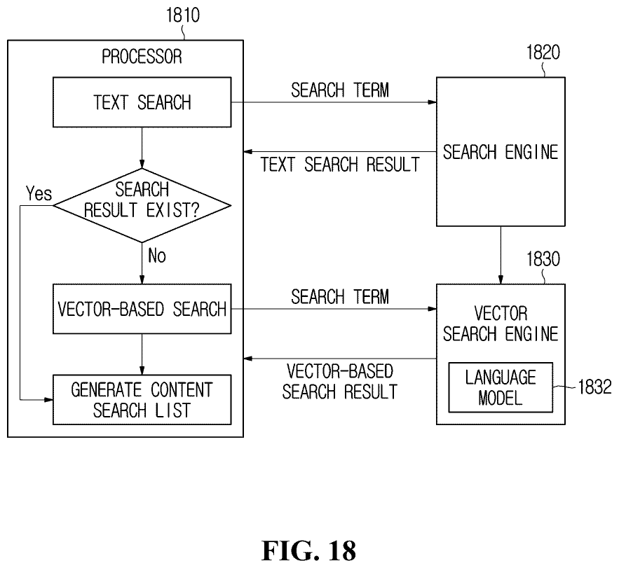

FIG. 17 illustrates another example of a procedure of searching for content by using a trained language model according to one embodiment of the present disclosure. Hereinafter, at least some operations of FIG. 17 may be performed sequentially or performed in parallel. For example, some operations of FIG. 17 may be performed at least temporarily at the same time. Hereinafter, at least some operations of FIG. 17 will be described with reference to FIG. 18. FIG. 18 illustrates an example of search scenario according to one embodiment of the present disclosure.

Referring to FIG. 17, in step S1701, the server detects a search event. The search event may be detected by receiving a content search request from a client device. For example, the server may detect the search event by receiving a content search request message including a text data-type search term.

In step S1703, the server performs text search. In other words, the server may retrieve a content item corresponding to the text-type search term by using a search engine. For example, as illustrated in FIG. 18, a processor 1810 of the server may request retrieval of content items corresponding to a text-type search term to a search engine 1820 by transmitting the search term to the search engine 1820 for text search and may receive a search result from the search engine 1820. The search engine 1820 may search for the content items corresponding to words included in the text-type search term by storing and managing content items in a word-based inverted index method. When there is a content item corresponding to words included in the search term, the search engine 1820 may provide a search result including information on the content item to the processor 1810. When there is no content item corresponding to words included in the search term, the search engine 1820 may notify the processor 1810 that no content item has been retrieved. According to one embodiment, the search engine 1820 may be an Elasticsearch-based distributed search and analysis engine. However, the search engine according to embodiments of the present invention is not limited to any Elasticsearch-based engine.

In step S1705, the server determines whether there is a search result of text search. For example, as illustrated in FIG. 18, the server may determine whether a text result obtained from the search engine 1820 includes information on at least one content item.

When there is a search result of text search, the server may, in step S1713, generate and provide a search list based on the search result. In other words, the server may generate a content search list including information on at least one content item included in the search result and may provide the generated content search list to the client device. For example, the server may transmit a content search list including information on at least one content item retrieved through text search to the client device.

When there is no search result for text search, the server may, in step S1707, determine a vector of the search term by using a trained language model. For example, as illustrated in FIG. 18, the processor 1810 of the server may determine that a vector-based search is to be performed, when there is no search result for text search. The processor 1810 of the server may request a vector-based content search by transmitting a search term to a vector search engine 1830. Accordingly, the vector search engine 1830 may determine the vector of the search term by using a language model 1832. For example, the vector search engine 1830 may divided the search term in token units and then insert at least one separator, thereby obtaining the search term that has been converted to any one input format among the input formats of Table 6. In addition, the vector search engine 1830 may obtain the vector of the search term by inputting the converted search term to the language model 1832. Herein, the language model 1832 may be a language model that is trained by the model learning unit 620. However, except for a head layer (e.g., MLM head layer or text classification head layer) used for learning in a prediction model, for similarity calculation, a last hidden layer embedding value of the language model itself may be used as an embedding value for the text metadata of a content.

In step S1709, the server determines the similarity with the vector of each content item. That is, the server may obtain a vector of each content item and determine similarity between the vector of the search term and a vector of each content item. According to one embodiment, the vector search engine 1830 may obtain the vector of each content item by using the language model 1832 illustrated in FIG. 18. For example, the vector search engine 1830 may obtain content items that satisfy a specified first condition from the search engine 1820 or a DB linked to the search engine 1820 and may determine vectors of the content items by using the language model 1832. Herein, the specified first condition may include a condition related to at least one of a storage time, a storage location, and/or classification. For example, the content items that satisfy the specified first condition may be all content items stored in the server, new content items that are additionally stored in the server within a specified period, content items corresponding to a specified classification, or content items stored in a specified location. The vector search engine 1830 may obtain the text metadata of each content item, perform tokenization on the obtained text metadata, and then obtain the sequence-type text data of each content item by inserting at least one separator. In addition, the vector search engine 1830 may obtain a vector corresponding to the sequence-type text data of each content item by using the trained language model 1832.

According to one embodiment, the vector search engine 1830 may obtain vectors of previously stored content items from a repository within the vector search engine 1830, a DB linked to the vector search engine 1830, the search engine 1820, or a DB linked to the search engine 1820. The vector search engine 1830 may determine similarity between the vector of the search term and the vector of each content item by using a similarity calculation algorithm. Herein, the similarity between the vector of the search term and the vector of each content item may be determined as similarity between the search term and the content item.

In step S1711, the server may generate and provide a search list based on the similarity. That is, the server may determine at least one content item similar to the search term, based on the similarity between the search term and the content item, and may generate a content search list including information on the at least one determined content item. For example, as illustrated in FIG. 18, the vector search engine 1830 may select, among the content items that satisfy the specified first condition, a predetermined number of content items in descending order of similarity to the search term or content items having a similarity equal to or higher than a threshold value. In addition, the vector search engine 1830 may provide a vector-based search result including information on the selected content items to the processor 1810. The processor 1810 may generate a content search list including information on at least one content item included in the search result and may transmit the generated content search list to a client device. Herein, a specific form of the content search list may be different according to an environment, a service, and the like, in which the content search result is provided.

In FIG. 17 and FIG. 18 described above, a server performs text search for a search term, and when there is no text search result, that is, when not even one content item is retrieved after the text search is performed, performs vector-based search. However, when a text search result for a search term does not satisfy specified search quality, the server may also perform vector-based search. The specified search quality may include a condition related to the number of retrieved content items, a condition related to a text matching score of the retrieved content items, or a condition related to an actual click-through rate for the retrieved content items based on the number of user searches. However, even when a text search result for a search term is a specified number of content items or fewer, the server may perform vector-based search. For example, when the number of content items obtained through text search for the search term is less than or equal to a specified number, the server may additionally search for at least one content item by performing vector-based search using a language model. As another example, when a text matching score of a content item retrieved by text search is equal to or less than a specified score, the server may perform vector-based search to further retrieve at least one content item. The text matching score means a score that represents similarity between a search term and a retrieved content item and may be calculated based on the term frequency-inverse document frequency (TF-IDF) or the best matching 25 (BM25). As still another example, when an actual click-through rate for a retrieved content item based on the number of user searches is equal to or less than a specified value, the server may perform vector-based search. An actual click-through rate based on the number of user searches may be calculated based on a user's search history and/or the user's feedback history for a search result. For example, the actual click-through rate based on the number of user searches may be calculated based on feedback history from a client device that indicates whether a user has clicked on (or select) a retrieved content item, after information on the retrieved content item is provided to the client device as a result for a same previous search term or a similar or different search term. Herein, the server may generate a content search list including information on a content item obtained through text search and information on at least one content item that is additionally obtained through vector-based search.

According to one embodiment, when there is no search result for text search of a search term, the server may store the search term as a no result (NR) search term. In addition, after transmitting the content search list for a search term to the client device, the server may receive, from the client device, feedback regarding whether the user has clicked on (or selected) at least one content item in the content search list. When at least one content item in the content search list is not clicked, the server may store the search term corresponding to the content search list as an NR search term. NR search term may be stored according to each user and/or each client device.

According to one embodiment, when a new content item is detected with an NR search term being stored, the server may calculate similarity between the NR search term and the new content item. The similarity between the NR search term and the content item may be calculated based on a vector of the NR search term and a vector of the new content item, which are obtained by using a trained language model. When the calculated similarity is equal to or greater than a specified threshold value, the server may transmit a recommend notification message for recommending the new content item to a client device corresponding to a user of the NR search term. Herein, the recommend notification message may be provided in the form of a push message. For example, the server may determine the new content item as a recommended content item of the NR search term and may transmit a push message to the client device notifying that there is a new content item related to the user's previous search term.

According to one embodiment, the server may delete an NR search term, when a specified deletion condition for the NR search term is satisfied. For example, after transmitting a recommend notification message related to a first NR search term to a client device, the server may delete the first NR search term from it when receiving a feedback message from the client device notifying that a new content item in the recommend notification message related to the first NR search term has been clicked or selected by a user. As another example, when an operation of transmitting a recommend notification message related to a second NR search term to a client device is performed a specified number of times, the server may delete the second NR search term from it. As still another example, irrespective of whether a recommend notification message related to a third NR search term is transmitted, when a storage period of the third NR search term exceeds a specified period, the server may delete the third NR search term from it.

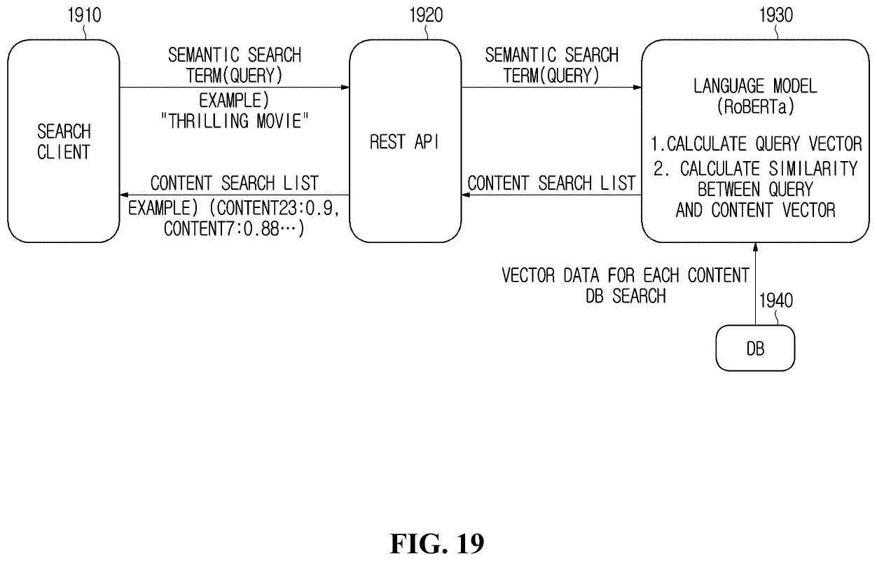

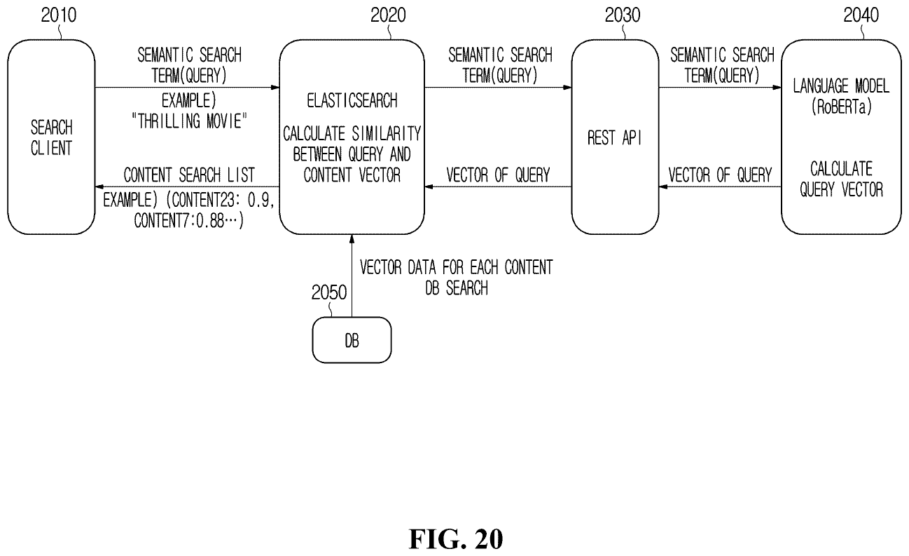

According to various embodiments of the present disclosure, a server may calculate similarity between a search term and a content by using a python module and/or an elasticsearch module. For example, similarity between a search term and a content may be calculated in a python module as illustrated in FIG. 19 or may be calculated in an elasticsearch module as illustrated in FIG. 20.

FIG. 19 illustrates an example of performing a search based on a Python module according to one embodiment of the present disclosure. Referring to FIG. 19, a search client 1910 transmits a semantic search term or a query including the semantic search term to a language model 1930 through a representational state transfer (REST) application programming interface (API) 1920. For example, the semantic search term may be a natural language phrase including at least one keyword, such as “thrilling movie.” Since a semantic search term should be processed in real time, the semantic search term may be provided to the language model 1930 of a python module via the REST API 1920. The REST API 1920 is an application programming interface that conforms to the constraints of the REST architectural style and enables interactions with RESTful web services.

The language model 1930 calculates a vector of a semantic search term received through the REST API 1920 and calculates similarity between the vector of the semantic search term and a content vector. The language model 1930 is a CBF model that processes natural language and may be, for example, RoBERTa. The language model 1930 may be trained based on text metadata of contents. According to one embodiment, the language model 1930 may store vector values of content items that are used to train the language model 1930 in a DB 1940. According to one embodiment, the language model 1930 may calculate vector values of content items, when a specified event occurs, and may store the calculated vector values of the content items in the DB 1940. When calculating similarity between a vector of a semantic search term and a content vector, the language model 1930 may use the vector values of the content items stored in the DB 1940.

The language model 1930 may select at least one or more content items based on similarity between a semantic search term and content items and may provide a content search list including information on the selected content items to the search client 1910 through the REST API 1920. Herein, the information on the content items may include at least one of identification information of the content items or information on the similarity to the search term.

According to one embodiment, the python module may select at least one content item based on the similarity between the semantic search term and the content items and then may perform post-processing logic to perform filtering on the at least one selected content item. For example, by filtering an unpopular content item or a user-disliked content item from the at least one selected content item, the python module may generate a content search list that excludes the unpopular content item or the user-disliked content item.

As described in FIG. 19, calculating the similarity between a search term and a content in a python module is advantageous in the easiness of management because the python module performs every operation for vector-based search.

FIG. 20 illustrates an example of performing a search based on an elastic search engine according to one embodiment of the present disclosure. Referring to FIG. 20, a search client 2010 transmits a semantic search term or a query including the semantic search term to Elasticsearch 2020. For example, the semantic search term may be “a thrilling movie”. Elasticsearch 2020 transmits the semantic search term or the query including the semantic search term to a language model 2040 of a python module through a REST API 2030.

The language model 2040 calculates a vector of the semantic search term received through the REST API 2030 and transmits a vector of the semantic search term to Elasticsearch 2020 through the REST API 2030. The language model 2040 is a CBF model that processes natural language and may be, for example, RoBERTa. The language model 2040 may be trained based on text metadata of contents.

Elasticsearch 2020 calculates similarity between the vector of the semantic search term and a content vector. Elasticsearch 2020 may obtain vector values of respective content items that are stored in advance in a DB 2050 and may calculate similarity between the semantic search term and the content vector by using the obtained vector values of respective content items. Before obtaining a vector value for a semantic search term from the language model 2040 through the REST API 2030, Elasticsearch 2020 needs to obtain a vector of each content item, which is in sync with the language model 2040, from the DB 2050. Elasticsearch 2020 may calculate similarity between the vector of the semantic search term obtained through the REST API 2030 and respective vectors of content items that are obtained in advance. The DB 2050 may obtain and store vector values of content items from the language model 2040.

Elasticsearch 2020 may select at least one or more content items based on the similarity between the semantic search term and the content items and may provide a content search list including information on the selected content items to the search client 2010. Herein, the information on the content items may include at least one of identification information of the content items or information on the similarity to the search term. According to one embodiment, Elasticsearch 2020 may select at least one content item based on the similarity between the semantic search term and the content items and then may perform post-processing logic to perform filtering on the at least one selected content item. For example, by filtering an unpopular content item or a user-disliked content item from the at least one selected content item, Elasticsearch 2020 may generate a content search list that excludes the unpopular content item or the user-disliked content item. As another example, Elasticsearch 2020 may perform filtering on the at least one selected content item by using features of various content items held in it.

As described in FIG. 20, calculating the similarity between the vector of a search term and a content in Elasticsearch 2020 is advantageous in achieving high service performance (e.g., latency or throughput).

Elasticsearch of FIG. 19 and FIG. 20 is merely one example of a search engine module, and the embodiments of the present disclosure are not limited thereto. For example, it is obvious to those skilled in the art that various search engine modules (e.g., Lucene, Solr) may be used instead of Elasticsearch to support the functions (e.g., cosine similarity search function) required for vector search within an inverted index structure. In addition, the REST API of FIG. 19 and FIG. 20 is merely one example of an API, and the embodiments of the present disclosure are not limited thereto. For example, it is obvious to those skilled in the art that other APIs such as a simple object access protocol (SOAP) API may be used instead of the REST API.

In the foregoing description, a vector of a search term is obtained in real time in a server through a language model. However, according to various embodiments, a vector of a search term may be calculated in advance through a language model and then may be stored in a server. For example, a server may store vector values of search terms that satisfy a specified second condition in a DB. The specified second condition may include a condition for the number of search requests and/or search frequency. For example, when search requests for a first search term occur a specified number of times or more, the server may store a vector value of the first search term in a DB. As another example, when search requests for a second search term occur a specified number of times or more within a specified period, the server may store a vector value of the second search term in the DB. In this case, the server may generate a content search list by using a vector of a search term stored in the DB.

FIG. 21A illustrates an example of the structure of a transformer applicable to an embodiment of the present disclosure, and FIG. 21B illustrates an example of the detailed structure of encoder and decoder blocks of a transformer applicable to an embodiment of the present disclosure.

Referring to FIGS. 21A and 21B, the transformer 2100 may include N encoder blocks 2110-1 to 2110-N and N decoder blocks 2120-1 to 2120-N. Each of the N encoder blocks 2110-1 to 2110-N may include a self-attention block 2111 and a feed forward block (or neural network) 2113. Each of the N decoder blocks 2120-1 to 2120-N may include a self-attention block 2121, an encoder-decoder attention block 2123, and a feed forward block 2125.

The input of the transformer 2100 may be tokenized, embedded, added with a positional encoding vector, and then input to the first encoder block 2110-1 located at the bottom among the N encoder blocks 2110-1 to 2110-N. Each self-attention block 2111 of the N encoder blocks 2110-1 to 2110-N may determine a word to focus on among several input words. The self-attention block 2111 may multiply the input embedding vector by three learnable matrices, respectively, to generate a query vector, a key vector, and a value vector. The self-attention block 2111 may be a multi-headed attention block having multiple attention heads and representing each vector in a different representation space for each purpose using the plurality of query vectors, key vectors, and value vectors. The output of the self-attention block 2111 may pass through the neural network of the feed forward block 2113 and be input to the next encoder block (e.g., the second encoder block 2110-2).

The output of the N-th encoder block 2110-N located at the top among the N encoder blocks 2110-1 to 2110-N may be a key vector and a value vector, which are attention vectors, and these may be input to the encoder-decoder attention block 2123 of each of the N decoder blocks 2120-1 to 2120-N.

The previous output of the transformer 2100 may be used as an input of the first decoder block 2120-1 located at the bottom among the N decoder blocks 2120-1 to 2120-N. For example, the previous output of the transformer 2100 may be tokenized, embedded, added with a positional encoding vector, and then input to the first decoder block 2120-1.

The self-attention block 2121 of each of the N decoder blocks 2120-1 to 2120-N is similar to the self-attention block 2111 of each of the N encoder blocks 2110-1 to 2110-N. However, the self-attention block 2121 of each of the N decoder blocks 2120-1 to 2120-N differs from the self-attention block 2111 of each of the N encoder blocks 2110-1 to 2110-N in that it performs masking so that it may only attend to positions previous to the current position within the output sequence.

Each encoder-decoder attention block 2123 of the N decoder blocks 2120-1 to 2120-N may generate an output by taking as input a query vector output from the self-attention block 2121 and the key vector and the value vector output from the N-th encoder block 2110-N.

The output vector of the N-th decoder block 2120-N located at the top among the N decoder blocks 2120-1 to 2120-N may be input to a linear layer 2130 and a SoftMax layer 2140. The linear layer 2130 and the SoftMax layer 2140 may change the output vector of the N-th decoder block 2120-N to a single word. The linear layer 2130 is configured as a fully-connected neural network and may project the output vector of the N-th decoder block 2120-N into a logit vector, which is a vector with a larger size. Each cell of the projected logit vector may have a score for each corresponding word. The SoftMax layer 2140 may convert the scores of each cell into a probability. The transformed probability values of each cell all have positive values, and the sum of each probability value may be 1. At this time, the word corresponding to the cell with the highest probability value may be output as the final result of the SoftMax layer 2140. The output of the SoftMax layer 2140 may be re-embedded and added to the positional encoding vector, and then input to the first decoder block 2120-1 located at the bottom.

Sub-blocks included in each of the N encoder blocks 2110-1 to 2110-N and the N decoder blocks 2120-1 to 2120-N may be connected in a residual connection manner, and a layer-normalization (or Add & normalize) block may be included between each of the sub-blocks. The layer-normalization block may combine the input and output of the self-attention blocks 2111 and 2121 to prevent excessive data change in one layer.

The transformer 2100 is a neural network that learns the context and meaning of a sentence by tracking the relationship between words in the sentence, and may mathematically find patterns between elements without a labeled data set. Therefore, the transformer 2100 does not require a process of generating a data set, and may be fast because it is suitable for parallel processing.

RNN (Recurrent Neural Network) has been widely used in the field of natural language processing because it may have position information of each word due to its characteristic of sequentially receiving and processing words according to the positions of the words. However, RNN has the problem of being difficult to process in parallel and having long-term dependency. On the other hand, the transformer may capture the dependency between input and output by using the attention mechanism instead of RNN. In addition, the transformer applies attention to the position of each word in the encoder block during learning, that is, emphasizes the value that is most closely related to the query, and uses the masking technique in the decoder block, so parallel processing is possible.

The sizes of the encoder/decoder input/output of the transformer, the number of encoders/decoders, the number of attention heads, and/or the size of the hidden layer of the feed-forward neural network are hyperparameters that may be changed by the user.

The BERT model is a transformer-based language model as described above, and may be used by replacing or deleting some components of the transformer. FIG. 22 illustrates an example of a structure of a BERT model applicable to one embodiment of the present disclosure. For example, the BERT model 2200 may be a model that uses encoder blocks 2110-1 to 2110-N except for decoder blocks 2120-1 to 2120-N in the transformer, as illustrated in FIG. 22.

In the BERT model, a [CLS] token may be placed at the beginning of an input sentence, and a [SEP] token may be used at the end of the sentence to separate the sentences. The output embedding after the BERT operation may be an embedding that takes into account all the contexts of the sentence. For example, [CLS] is a simple embedding vector that has passed the embedding layer when inputting BERT, but when it passes through the BERT model, it may become a vector with context information that takes into account all the word vectors in the sentence.

Natural language processing using a transformer-based model such as the BERT model may be performed in two steps. The two steps may include a pre-training step in which a large-scale encoder embeds input sentences to model a language, and a step of fine-tuning a model trained through pre-training to perform various natural language processing tasks.

The BERT model is a pre-trained model, and since it performs pre-training embedding before performing a specific task, it is receiving attention as a model that can further improve the performance of the task than existing embedding technologies. In the modeling process that applies the BERT model, pre-training is performed in an unsupervised learning manner, and the encoder embeds a large corpus, transfers it, and performs fine-tuning to perform learning suitable for the purpose, thereby performing the task. Another feature of the BERT model is that it considers the context before and after the sentence by applying a bidirectional model, so it can show higher accuracy than before.

As described above, the language model trained according to the embodiment of the present disclosure obtains a vector of content by comprehensively considering not only the hashtag information but also the semantic information and/or the context information of other types of features, and calculates the similarity between a search term and the content based on the vector. Therefore, the method of determining the similarity between a search term and content based on the language model according to the embodiment of the present disclosure may be said to be different from simply filtering contents having similar metadata to the search term.

The exemplary methods of the present disclosure are represented in a series of operations for clarity of description, but this is not intended to limit the order in which the steps are performed, and each step may be performed simultaneously or in a different order, if necessary. In order to realize a method according to the present disclosure, the steps illustrated may include further other steps, or may include the remaining steps with the exception of some steps, or may include additional other steps with the exception of some steps.

Various embodiments of the present disclosure are not intended to enumerate all possible combinations, but to describe a representative aspect of the present disclosure, and the matters described in the various embodiments may be applied independently or in combination of two or more.

In addition, various embodiments of the present disclosure may be realized by hardware, firmware, software, or a combination thereof. In the case of hardware realization, the embodiments may be realized by one or more ASICs (Application Specific Integrated Circuits), DSPs (Digital Signal Processors), DSPDs (Digital Signal Processing Digital Signal Processing Devices (DSPs), Programmable Logic Devices (PLDs), Field Programmable Gate Arrays (FPGAs), general processors, controllers, microcontrollers, microprocessors, etc.

The scope of the present disclosure includes software or machine-executable commands (e.g., operating systems, applications, firmware, programs, etc.) that allow an operation according to a method of various embodiments to be performed on a device or computer, and a non-transitory computer-readable medium in which such software or commands are stored and executed on the device or computer.

What is claimed is:

1. A method for operating a server in a content streaming system, the method comprising:
obtaining a search term;
determining a first vector corresponding to the search term by using a language model trained based on synopsis information included in metadata of content items;
determining a similarity between the search term and a first content item based on the first vector corresponding to the search term and a second vector of the first content item; and
providing a content search list including information on at least one content item including the first content item selected based on the similarity.

2. The method of claim 1, wherein the second vector of the first content item is obtained through the language model that is trained based on the synopsis information.

3. The method of claim 2, wherein the second vector of the first content item is obtained by inputting sequence-type text data, which includes information included in first metadata of the first content item, into the language model trained based on the synopsis information.

4. The method of claim 1, wherein the language model is trained based on a masked language model (MLM) through training to predict the synopsis information of the content items.

5. The method of claim 4, wherein the language model is primarily trained based on the MLM through training to predict the synopsis information of the content items and is secondarily trained based on the MLM through training to predict hashtag information of the content items.

6. The method of claim 4, wherein the language model is primarily trained based on the MLM through training to predict hashtag information of the content items and is secondarily trained based on the MLM through training to predict the synopsis information of the content items.

7. The method of claim 1, wherein the determining of the first vector corresponding to the search term comprises:
dividing the search term into token units;
obtaining a transformed search term by inserting at least one separator into the search term that is divided into token units; and
obtaining the first vector by inputting the transformed search term into the language model.

8. The method of claim 7, wherein the transformed search term includes at least one of a separator token or a special token.

9. The method of claim 1, further comprising:
converting text metadata describing content of the content items into sequence-type text data;
masking a synopsis token located in a synopsis region of the sequence-type text data; and
performing training of the language model to predict the masked synopsis token, and
wherein the text metadata includes at least one of a title, a synopsis, a composite genre, a director, an actor, or hashtag information.

10. The method of claim 9, wherein the converting of the text metadata into the sequence-type text data comprises:
dividing the text metadata into a plurality of tokens; and
generating the sequence-type text data by inserting at least one separator between the tokens, and
wherein the at least one separator includes at least one of a separator token for separating different types of features or a special token inserted before and after a specific feature to indicate the specific feature.

11. The method of claim 9, wherein the masking of the synopsis token comprises:
selecting a non-dependent token from among a plurality of synopsis tokens located in the synopsis region; and
masking the selected non-dependent token, and
wherein the non-dependent token is a token that does not start with a specified symbol.

12. The method of claim 9, wherein the training is performed by using a prediction model, and
wherein the prediction model includes the language model that receives, as input, sequence-type text data including a masked synopsis token and outputs vector values corresponding to the sequence-type text data, and a masked language model (MLM) head layer that is configured to predict at least one input token corresponding to at least one vector value that is output from the language model.

13. The method of claim 1, wherein each of the first vector and the second vector is determined by assigning a weight to a vector value corresponding to a location of a specified feature among output vector values of a last hidden layer of the trained language model.

14. The method of claim 1, further comprising determining similarity between the search term and a plurality of content items based on the first vector corresponding to the search term and a vector of each of the plurality of content items,
wherein the providing of the content list comprises:
selecting two or more content items including the first content item from among the first content item and the plurality of content items, in descending order of similarity to the search term; and
providing the content list including information on the selected two or more content items.

15. The method of claim 1, further comprising, prior to determining the first vector corresponding to the search term, performing a text search based on the search term,
wherein when a result obtained from the text search does not satisfy a specified condition, the determining of the first vector corresponding to the search term is performed.

16. The method of claim 15, wherein the specified condition comprises a condition regarding at least one of whether at least one content item is retrieved, or the number of retrieved content items.

17. A server in a content streaming system, the server comprising:
a communication unit configured to transmit and receive signals with at least one client device; and
a processor electrically coupled with the communication unit,
wherein the processor is configured to:
obtain a search term,
determine a first vector corresponding to the search term by using a language model that is trained based on synopsis information included in metadata of content items,
determine a similarity between the search term and a first content item based on the first vector corresponding to the search term and a second vector of the first content item, and
provide a content search list including information on at least one content item including the first content item selected based on the similarity.

18. A non-transitory computer-readable medium storing instructions that, when executed by a processor, cause to the processor to perform the method of claim 1.
